(19) United States
(12) Patent Application Publication
(10) Pub. No.: US 2023/0133171 A1
(43) Pub. Date: May 4, 2023

(54) Thermoplastic Elastomer Compositions, Their Preparation and Use in Fiber-Reinforced Spoolable Pipes

(71) Applicant: Celanese International Corporation, Irving, TX (US)

(72) Inventors: Krishnan Anantha Narayana Iyer, Manvel, TX (US); Antonios K. Doufas, Houston, TX (US); Wanli Wang, Shanghai (CN); Warren P. Jones, Missouri City, TX (US); Deborah J. Davis, League City, TX (US)

(21) Appl. No.: 17/912,239

(22) PCT Filed: Mar. 16, 2021
(86) PCT No.: PCT/US2021/022549

§ 371 Date: Sep. 16, 2022

Related U.S. Application Data
(60) Provisional application No. 62/991,325, filed on Mar. 18, 2020.

(51) Int. Cl. F16L 11/08; B32B 25/04; B32B 25/02; B32B 27/32; F16L 59/153; B32B 27/22; B32B 27/20

(52) U.S. Cl. CPC F16L 11/083; B32B 25/042; B32B 25/02; B32B 27/325; F16L 59/153; B32B 27/22; B32B 27/20; B32B 2274/00; B32B 2597/00; B32B 2270/00; B32B 2307/54; B32B 2307/30

(57) ABSTRACT

A spoolable pipe (100) comprising: a barrier layer (104) formed around a longitudinal axis of the pipe; a reinforcing layer (105) disposed around the barrier layer comprising a fiber material; and an outer layer (110), wherein at least one of the reinforcing layer (105) and the outer layer (110) comprises a thermoplastic elastomer (TPE) composition comprising a thermoplastic matrix and a rubber phase dispersed in the thermoplastic matrix and having a thermal conductivity of about 0.2 W/m-K or less.

### CROSS-REFERENCE TO RELATED APPLICATIONS

This application claims the priority benefit of U.S. Ser. No. 62/991,325, filed Mar. 18, 2020, which is incorporated herein by reference.

### FIELD

The present disclosure relates generally to spoolable tubing, and more particularly to spoolable tubing or pipes having an advantageous external layer that reduces spool strain and gas incursion strain.

### BACKGROUND

Fiber-reinforced spoolable pipes/tubing capable of being wound or spooled on a reel (e.g., for transportation, storage) is commonly used in oil well operations. For example, oil well operations include running wire line cable down-hole with well tools, working over wells by delivering various chemicals down-hole, and performing operations on the interior surface of the drill hole. The piping is spoolable so that it can be used with one well, and then transported on a reel a different well location and used again. Such piping should be able to withstand repeated spooling and unspooling without damage to the pipe microstructures as well as spooling to high strains (e.g., at least about 1%).

Traditional spoolable pipe is a three-layer product with an internal pressure barrier layer, an internal reinforcing layer, and an external layer. Generally, the external layer is formed of a material that has a higher gas permeability than the internal pressure layer so that any gases that enter into the pipe structure can be expelled. However, it is known in the art that even spoolable pipe having an external layer that has a permeability five times greater than the internal pressure layer, is subject to stress and potential rupture from corrosion by gases, such as CO₂ and H₂S that enter the pipe structure. Although U.S. Pat. No. 8,678,041 describes that an external sheath should have a gas permeability at least five times greater, preferably ten times greater, than the gas permeability of the internal pressure barrier, it does not describe specific materials leading to that property.

The current polymeric materials used for external sheath such as high-density polyethylene (HDPE), cross-linked polyethylene, polyvinylidene fluoride (PVDF), polyamide, polypropylene, polyethylene terphthalate, and polyphenylene sulfide (PES) are subject to both spooling stress and gas incursion stress. This is particularly true of HDPE and polyamide-11 (PA11), which have extremely low permeability for the acid gases, thereby further exacerbating the corrosion.

Therefore, there is a need for developing materials that exhibit excellent flexibility as well as high gas permeability, preferably without sacrificing other highly desirable properties such as strength, thermal conductivity, abrasion resistance, and the like. Improvement in any of these properties would provide strategies for improving the longevity of a fiber-reinforced spoolable pipe, thereby avoiding costly repairs and replacements.

### SUMMARY

The present disclosure provides a spoolable pipe comprising: a barrier layer formed around a longitudinal axis of the pipe; a reinforcing layer disposed around the barrier layer comprising a fiber material; and an outer layer, wherein at least one of the reinforcing layer and the outer layer comprises a thermoplastic elastomer (TPE) composition comprising a thermoplastic matrix and a rubber phase dispersed in the thermoplastic matrix and having a thermal conductivity of about 0.2 W/m·K or less. The TPE composition may further comprise one or more of a cyclic olefin copolymer (COC), siloxane-based slip agent, high-density polyethylene, and high melt strength polypropylene.

The present disclosure also provides a spoolable pipe comprising: a barrier layer formed around a longitudinal axis of the pipe; a reinforcing layer disposed around the barrier layer comprising a fiber material; an outer layer; and an insulating layer, the insulating layer comprising a TPE composition comprising a thermoplastic matrix and a rubber phase dispersed in the thermoplastic matrix and having a thermal conductivity of about 0.2 W/m·K or less. The TPE composition may further comprise one or more of a COC, siloxane-based slip agent, high-density polyethylene, and high melt strength polypropylene.

Additionally, the present disclosure provides a spoolable pipe comprising: a barrier layer formed around a longitudinal axis of the pipe; and a reinforcing layer disposed around the barrier layer comprising a fiber material; an outer layer; and optionally an insulating layer, wherein at least one of the reinforcing layer, the outer layer, and the insulating layer comprises a TPE composition comprising a thermoplastic matrix and a rubber phase dispersed in the thermoplastic matrix and having a CO₂ permeability at 60° C. of at least about 6 barrers

$$( {6}^{- 9} \frac{{cm}_{STP}^{3} \cdot cm}{{cm}^{2} \cdot s \cdot cm Hg} ) .$$

The TPE composition may further comprise one or more of a COC, siloxane-based slip agent, and high melt strength polypropylene.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is a perspective view, in successive layers, of an illustrative embodiment of a fiber-reinforced spoolable pipe;

FIG. 2 is a perspective view, in successive layers, of an illustrative embodiment of a fiber-reinforced spoolable pipe comprising an insulating layer; and

FIG. 3 is a perspective view, partly cut away, of one embodiment of a fiber-reinforced spoolable pipe.

### DETAILED DESCRIPTION

The present disclosure relates generally to spoolable tubing, and more particularly to spoolable tubing or pipes having an advantageous external layer that reduces spool strain and gas incursion strain. The advantageous external layer is formed of a thermoplastic elastomer instead of the more traditional polymeric materials, such as those described above.

Various terms as used herein are defined below. To the extent a term used in a claim is not defined below, it should be given the broadest definition persons in the pertinent art have given that term as reflected in one or more printed publications or issued patents.

The term “thermoplastic elastomeric composition,” “thermoplastic elastomer,” or “TPE,” is broadly defined as any material that includes a thermoplastic matrix (or thermoplastic phase) and an elastomeric or rubber phase, which may be fully cross-linked, partially cross-linked, or not cross-linked at all. A TPE may include additives such as, but not limited to, fillers, process oils, stabilizers, compatibilizers, plasticizers, antioxidants, and the like.

The term “spoolable pipes” means flexible pipes and umbilicals, as well as flexible pipes combining the functions of flexible pipes and umbilicals, suitable for use in oil well applications.

The present disclosure relates to thermoplastic elastomer (TPE) compositions comprising a thermoplastic polymer and a rubber having one or more of the following characteristics: excellent fatigue resistance, good tensile properties, good fabricability, good processability, good abrasion resistance, good creep resistance, and/or high gas permeability. In some examples, TPE compositions further include a cyclic olefin copolymer (COC) and exhibit surprisingly increased gas permeability compared to similar TPE compositions. In some examples, TPE compositions further include a hydrocarbon resin and exhibit surprisingly increased gas permeability compared to similar TPE compositions. In other examples, TPE compositions further include a polyolefin compatibilizer, preferably block copolymer, and exhibit excellent processability and tensile properties compared to similar TPE compositions. In yet further examples, TPE compositions employ a low-molecular-weight ester-based plasticizer and exhibit improved low temperature fatigue performance.

It has now been unexpectedly found that certain specific TPE compositions exhibit excellent gas permeability for use as an external layer of a flexible conduit for transporting fluids in hydrocarbon production. In some cases, the TPE is a thermoplastic elastomer polyolefinic rubber blend (TPO) or a thermoplastic vulcanizate (TPV). Advantageously, some TPE compositions exhibit substantially reduced thermal conductivity when compared to incumbent materials. Some TPE compositions include a siloxane-based slip agent to provide higher abrasion resistance. Yet other TPE compositions include a hydrosilation cure agent or a moisture cure via silane grafting cure agent, without slip agents, to provide higher abrasion resistance.

As such, TPE compositions may be used in forming one or more layers of a flexible pipe, tubing, hose, or flexible structure, such as flexible pipes and flexible umbilicals used in transporting fluids in petroleum production. Such articles may be formed by extrusion, calendaring, molding (e.g., injection or compression or blow molding), or other suitable thermoplastic elastomer processing techniques. More specifically, in one embodiment, a spoolable pipe may comprise a barrier layer formed around a longitudinal axis of the pipe; a reinforcing layer disposed around the barrier layer comprising a fiber material; and an outer layer. Advantageously, at least one of the reinforcing layer and the outer layer comprises a thermoplastic elastomer (TPE) composition comprised of a thermoplastic matrix and a rubber phase dispersed in the thermoplastic matrix and having a thermal conductivity of about 0.2 W/m·K or less.

In another example, an embodiment of a spoolable pipe may comprise a barrier layer formed as a tube, the tube having an outer surface and an inner surface defining an inner diameter; a reinforcing layer at least partially bonded to the outer surface of the barrier layer, the reinforcing layer comprising a first ply of reinforcing tape helically wrapped in a first helical direction about the barrier layer and a second ply of reinforcing tape helically wrapped about the first ply of reinforcing tape in a second helical direction counter to the first helical direction; and an outer layer applied over and at least partially bonded to the reinforcing layer, the outer layer comprising a thermoplastic elastomer (TPE) composition comprised of a thermoplastic matrix and a rubber phase dispersed in the thermoplastic matrix and having a thermal conductivity of about 0.2 W/m·K or less.

It yet a further example, another embodiment of a spoolable pipe may comprise a barrier layer formed around a longitudinal axis of the pipe; a reinforcing layer disposed around the barrier layer comprising a fiber material; and an outer layer. Advantageously, at least one of the reinforcing layer and the outer layer comprises a thermoplastic elastomer (TPE) composition comprised of a thermoplastic matrix and a rubber phase dispersed in the thermoplastic matrix and having a CO₂ permeability at 60° C. of at least about 6 barrers

$$( {6}^{- 9} \frac{{cm}_{STP}^{3} \cdot cm}{{cm}^{2} \cdot s \cdot cm Hg} ) .$$

By employing the TPE compositions described herein, a flexible pipe exhibiting high gas permeability may also advantageously have a longer lifetime since acid gases trapped within the interior of the flexible pipe may permeate out of the flexible pipe.

Unless otherwise indicated, a “composition” includes components of the composition and/or reaction products of two or more components of the composition.

For the TPE compositions disclosed herein, the properties described above may be achieved without sacrificing ease of processability and mechanical properties such as hardness or gas permeability. As used herein, TPE compositions have a tensile strength at yield (measured in accordance with ISO 37) of about 5 MPa or more (e.g., about 10 MPa to about 30 MPa). The TPE compositions also have a tensile strain at yield (measured in accordance with ISO 37) ranging from a low of about 5%, about 15%, or about 25% to a high of about 100%, or about 200%. The TPE compositions may also have a creep strain, measured at 23° C. at a stress of about 4 MPa, of about 100% or less, such as about 40% or less, such as in a range from about 0.5% to about 30%, or such as in a range from about 1% to about 30%.

### Thermoplastic Matrix

The thermoplastic matrix of a TPE composition can include a polymer with a high temperature Vicat softening point, such as from about 100° C. to about 200° C. or about 130° C. to about 180° C., and/or a thermal conductivity of about 0.2 W/m·K or less, such as about 0.10 W/m·K to about 0.20 W/m·k or about 0.15 W/m·K to about 0.18 W/m·K. For example, the thermoplastic matrix of a TPE composition may include a polymer that can flow above its melting temperature.

The thermoplastic matrix of a TPE composition comprises a propylene-based thermoplastic polymer, an ethylene-based thermoplastic polymer, any other suitable polyolefin-based thermoplastic polymers, or any combination thereof. Said polymers may be a homopolymer, a random copolymer, an impact copolymer, or any combination thereof. For example, the thermoplastic matrix of a TPE composition may be a blend of two different thermoplastic polyolefins (e.g., polypropylene and polyethylene).

### Propylene-Based Thermoplastic Polymer

Propylene-based thermoplastic polymers may include solid resins, such as high-molecular-weight plastic resins, that primarily comprise units deriving from propylene polymerization. For example, at least 75%, such as at least 90%, at least 95%, or at least 99% of the units of a propylene-based polymer derive from propylene polymerization. In a particular example, these polymers include a homopolymer of propylene.

In embodiments employing a propylene-based thermoplastic polymer, the propylene-based thermoplastic polymer may comprise isotactic polypropylene. For example, isotactic polypropylene may have an isotactic index of greater than about 85% or greater than about 90%. A propylene-based polymer may also optionally include units deriving from ethylene polymerization and/or α-olefins such as 1-butene, 1-hexene, 1-octene, 2-methyl-1-propene, 3-methyl-1-pentene, 4-methyl-1-pentene, 5-methyl-1-hexene, and mixtures thereof.

The propylene-based polymer may exhibit one, more, or all of the following characteristics:
1) a crystallinity of at least about 25% or more, such as about 55% or more, such as about 65% or more, such as about 70% or more;
2) a heat of fusion (H_{f}) that is about 52.3 J/g or more, such as about 100 J/g or more, about 125 J/g or more, or about 140 J/g or more;
3) a weight average molecular weight (M_{w}) that is about 50,000 g/mol to about 2,000,000 g/mol, such as about 100,000 g/mol to about 1,000,000 g/mol, about 100,000 g/mol to about 600,000 g/mol, or about 400,000 g/mol to about 800,000 g/mol;
4) a number average molecular weight (Mₙ) that is about 25,000 g/mol to about 1,000,000 g/mol, such as about 50,000 g/mol to about 300,000 g/mol;
5) a Z-average molecular weight (M_{z}) that is about 70,000 g/mol to about 5,000,000 g/mol, such as about 100,000 g/mol to about 2,000,000 g/mol or about 300,000 g/mol to about 1,000,000 g/mol;
6) a melt flow index (MFI) that is about 0.1 g/10 minutes to about 50 g/10 minutes, such as about 0.5 g/10 minutes to about 5 g/10 min, or about 0.5 g/10 minutes to about 3 g/10 minutes;
7) a melt temperature (Tₘ) that is from about 110° C. to about 170° C., such as from about 140° C. to about 168° C., or from about 160° C. to about 165° C.;
8) a glass transition temperature (T_{g}) that is from about −50° C. to about 10° C., such as from about −30° C. to about 5° C., or from about −20° C. to about 2° C.; and
9) a crystallization temperature (T_{c}) that is about 75° C. or more, such as about 95° C. or more, about 100° C. or more, about 105° C. or more, or about 105° C. to about 130° C.

A thermoplastic matrix of a TPE composition may further include a high viscosity, long-chain branched (LCB) polyolefin that includes one, more, or all of the following characteristics:
1) a melt flow index (MFI) of about 10 g/10 minutes or less, such as about 8 g/10 minutes or less, about 5 g/10 minutes or less, about 2 g/10 minutes or less, or about 1 g/10 minutes or less;
2) a weight average molecular weight (M_{w}) of about 300,000 g/mol or more, such as about 350,000 g/mol or more, about 375,000 g/mol or more, or about 400,000 g/mol or more;
3) a weight average molecular weight (M_{w}) of about 600,000 g/mol or less, about 500,000 g/mol or less, or about 450,000 g/mol or less;
4) a Z-average molecular weight (M_{z}) of about 700,000 g/mol or more, such as about 800,000 g/mol or ore, about 1,000,000 g/mol or more, or about 1,100,000 g/mol or more;
5) a Z-average molecular weight (M_{z}) of about 2,000,000 g/mol or less, such as about 1,500,000 g/mol or less or about 1,300,000 g/mol or less;
6) a polydispersity index (M_{w}/Mₙ) of about 2.5 or more, such about 4.0 or more;
7) a number average molecular weight (Mₙ) of about 40,000 g/mol or more, such as about 50,000 g/mol or more, or about 60,000 g/mol or more;
8) a number average molecular weight (Mₙ) of about 200,000 g/mol or less, such as about 150,000 g/mol or less, or about 120,000 g/mol or less;
9) a high viscosity, long-chain branched polyolefin may be characterized by a polydispersity index (M_{w}/Mₙ) of about 2.7 or more, such as about 3.0 or more, about 3.3 or more, about 4.5 or more, about 5.0 or more, or about 5.5 or more; and
10) a viscosity average branching index (LCB-g′ᵥᵢₛ) of about 0.9 or less, such as about 0.7 or less, or about 0.5 or less.

Examples of propylene-based thermoplastic polymers useful for preparing the TPE compositions disclosed herein include EXXONMOBIL™ PP5341 (available from ExxonMobil Chemical Company of Houston, Tex., USA); ACHIEVE™ PP6282NE1 (available from ExxonMobil Chemical Company); BRASKEM™ F008F (available from Braskem of Philadelphia, Pa., USA); polypropylene resins with broad molecular weight distribution as described in U.S. Pat. Nos. 9,453,093 and 9,464,178; other polypropylene resins described in U.S. Pat. Pub. Nos. US2018/0016414 and US2018/0051160 (for example, PDH025 with an MFI of 2.6 g/10 minutes); WAYMAX™ MFX6 (available from Japan Polypropylene Corporation of Tokyo, Japan); Borealis DAPLOY™ WB140 (available from Borealis AG of Vienna, Austria); AMPPLEO™ 1025MA and AMPPLEO™ 1020GA (available from BRASKEM); and other suitable polypropylenes.

### Ethylene-Based Thermoplastic Polymer

Ethylene-based thermoplastic polymers include those solid, such as high-molecular weight plastic resins, that primarily comprise units deriving from ethylene polymerization. For example, at least about 90%, such as at least about 95%, or at least about 99% of the units comprising an ethylene-based polymer are derived from ethylene polymerization. For example, the ethylene based thermoplastic polymer may be a polyethylene homopolymer.

Optionally, an ethylene-based polymer may also include units derived from α-olefin polymerization, such as polymerization of one or more of propylene, 1-butene, 1-hexene, 1-octene, 2-methyl-1-propene, 3-methyl-1-pentene, 4-methyl-1-pentene, and 5-methyl-1-hexene.

Suitable ethylene-based polymers may exhibit one, more, or all of the following characteristics:
1) a melt flow index (MFI) that is from about 0.1 g/10 minutes to about 1,000 g/10 minutes, such as from about 1.0 g/10 minutes to about 200 g/10 minutes or from about 7.0 g/10 minutes to about 20.0 g/10 minutes;
2) a melt temperature (Tₘ) that is from about 140° C. to about 90° C., such as from about 135° C. to about 125° C. or from about 130° C. to about 120° C.); and
3) a density greater than 0.90 g/cm³.

Ethylene-based polymers are commercially available, for example, under the trade name EXXONMOBIL™ Polyethylene (available from ExxonMobil Chemical Company). Ethylene-based copolymers are commercially available under the trade name EXXONMOBIL™ Polyethylene (available from ExxonMobil Chemical Company), which include metallocene produced linear low density polyethylene including EXCEED™, ENABLE™, and EXCEED™ XP. Examples of ethylene-based thermoplastic polymers useful for preparing the TPE compositions described herein include EXXONMOBIL™ HD7800P, EXXONMOBIL™ HD6706.17, EXXONMOBIL™ HD7960.13, EXXONMOBIL™ HD9830, EXXONMOBIL™ AD60-007, EXCEED™ XP 8318ML, Exceed™ XP 6056ML, EXCEED™ 1018HA, ENABLE™ 2010 Series, ENABLE™ 2305 Series, and EXXONMOBIL™ LLDPE LL (e.g., 1001, 1002YB, 3003 Series, all available from ExxonMobil Chemical Company). Additional examples of ethylene-based thermoplastic polymers suitable for use in TPE compositions described herein include INNATE™ ST50 and DOWLEX™ (available from The Dow Chemical Company of Midland, Mich., USA).

One example of suitable PE is a crystalline PE, preferably a HDPE having a density of about 0.940 g/cc to about 0.965 g/cc and an MFI of about 0.1 g/10 minutes to about 20 g/10 minutes. HDPE is commercially available in different forms, each relatively high polydispersity index in a range from about 20 to about 40. For example, bimodal HDPE such as EXXONMOBIL™ HD 7800P may be used. EXXONMOBIL™ HD 7800P is available from ExxonMobil Chemical Company.

A thermoplastic matrix may comprise a polyethylene resin, for example, a polyethylene homopolymer. Suitable polyethylene may be characterized by a weight average molecular weight (M_{w}) of about 100 kg/mol to about 250 kg/mol, from about 110 kg/mol to about 220 kg/mol, or from about 150 kg/mol to about 200 kg/mol. Additionally or alternatively, suitable polyethylene may be characterized by a polydispersity index (M_{w}/Mₙ) that is about 12 or less, about 11 or less, about 10 or less, or about 9 or less.

Polyethylene may be present in a TPE composition as a blend with polypropylene, such as isotactic polypropylene, in an amount of about 5 wt % or more, about 7 wt % or more, about 10 wt % or more, or about 5 wt % to about 25 wt %, based on the weight of the TPE composition.

### Rubber

Examples of suitable rubbers that may be included in the TPE compositions described herein include, but are not limited to, olefinic elastomeric polymers, nitrile rubber, butyl rubber, alkyl acrylate copolymers (ACM), other suitable rubbers, mixtures, and blends thereof. Examples of olefinic elastomeric polymers include, but are not limited to, ethylene-based elastomers such as ethylene-propylene rubber (EPR). Suitable rubbers include those that are capable of being cured or cross-linked by a phenolic cure, by a hydrosilation cure (e.g., silane-containing curative), by moisture cure via silane grafting, by a peroxide curative, or by an azide curative. Alternatively, non-cross-linked rubbers may be used. Reference to a rubber may include blends and mixtures of more than one rubber.

### Ethylene-Propylene Rubber

The term ethylene-propylene rubber refers to rubbery polymers polymerized from ethylene and at least one other α-olefin monomer. An ethylene-propylene rubber may additionally include at least one diene monomer (e.g., an ethylene-propylene-diene (EPDM) terpolymer). Examples of suitable α-olefins include, but are not limited to, propylene, 1-butene, 1-hexene, 4-methyl-1-pentene, 1-octene, 1-decene, and combinations thereof, preferably propylene, 1-hexene, 1-octene or combinations thereof. Suitable diene monomers include, but are not limited to, 5-ethylidene-2-norbornene (ENB), 5-vinyl-2-norbornene (VNB), divinylbenzene, 1,4-hexadiene, 5-methylene-2-norbornene, 1,6-octadiene, 5-methyl-1,4-hexadiene, 3,7-dimethyl-1,6-octadiene, 1,3-cyclopentadiene, 1,4-cyclohexadiene, dicyclopentadiene, and any combination thereof. For example, a diene monomer may include sterically unhindered non-conjugated C—C double bonds, such as in ENB or VNB.

An ethylene-propylene rubber may include a diene in a range from about 1 wt % to about 15 wt %, such as from about 3 wt % to about 15 wt %, from about 5 wt % to about 12 wt %, or from about 7 wt % to about 11 wt %, based on the total weight of the ethylene-propylene rubber.

Suitable ethylene-propylene rubbers may exhibit one, more, or all of the following characteristics:
1) an ethylene-derived content of about 10 wt % to about 99.9 wt %, such as from about 10 wt % to about 90 wt %, from 12 wt % to about 90 wt %, from about 15 wt % to about 90 wt %, from about 20 wt % to about 80 wt %, from about 40 wt % to about 70 wt %, from about 50 wt % to about 70 wt %, from about 55 wt % to about 65 wt %, or from about 60 wt % and about 65 wt %, based on the total weight of the ethylene-propylene rubber;
2) an ethylene-derived content of about 40 wt % to about 85 wt %, such as from about 40 wt % to about 85 wt %, based on the total weight of the rubber;
3) a diene-derived content that is in a range from about 0.1 wt % to about to about 15 wt %, such as from about 0.1 wt % to about 5 wt %, from about 0.2 wt % to about 10 wt %, from about 2 wt % to about 8 wt %, from about 3 wt % to about 15 wt %, from about 4 wt % to about 12 wt %, or from about 4 wt % to about 9 wt %, based on the total weight of the rubber;
4) an α-olefin-derived content, such as C₂ to C₄₀ olefins, C₃ to C₂₀ olefins, C₃ to C₁₀ olefins, or propylene;
5) a weight average molecular weight (M_{w}) of about 100,000 g/mol or more, such as about 200,000 g/mol or more, about 400,000 g/mol or more, or about 600,000 g/mol or more.
6) a M_{w} of about 1,200,000 g/mol or less, such as about 1,000,000 g/mol or less, about 900,000 g/mol or less, or about 800,000 g/mol or less;
7) an M_{w} of about 500,000 g/mol to about 3,000,000 g/mol, such as from about 500,000 g/mol to about 2,000,000 g/mol, from about 500,000 g/mol to about 1,500,000 g/mol, from about 600,000 g/mol to about 1,200,000 g/mol, or from about 600,000 g/mol to about 1,000,000 g/mol;
8) a number average molecular weight (Mₙ) of about 20,000 g/mol or more, such as about 60,000 g/mol or more, about 100,000 g/mol or more, or about 150,000 g/mol or more;
9) an Mₙ of about 500,000 g/mol or less, such as about 400,000 g/mol or less, about 300,000 g/mol or less, or about 250,000 g/mol or less;
10) a Z-average molecular weight (Mₜ) of about 10,000 g/mol to about 7,000,000 g/mol, such as from about 50,000 g/mol to about 3,000,000 g/mol, from about 70,000 g/mol to about 2,000,000 g/mol, from about 75,000 g/mol to about 1,500,000 g/mol, from about 80,000 g/mol to about 700,000 g/mol, or from about 100,000 g/mol to about 500,000 g/mol;
11) a polydispersity index of about 1 to about 10, such as from about 1 to about 5, from about 1 to about 4, from about 2 to about 4, from about 1 to about 3, from about 1.8 to about 3, from about 1 to about 2, or from about 1 to 2.5;
12) a dry Mooney viscosity (ML (1+4) at 125° C.) of about 10 MU to about 500 MU, about 50 MU to about 450 MU, or about 250 MU or more, such as about 350 MU or more; and
13) a glass transition temperature (T_{g}), as determined by Differential Scanning calorimetry (DSC) of about −20° C. or less, such as about −30° C. or less, about −50° C. or from about −60° C. to about −20° C.

Examples of ethylene-propylene rubbers useful for preparing TPE compositions disclosed herein include EPDM rubbers, such as, but not limited to, those sold under the VISTALON™ tradename (available from ExxonMobil Chemical Company) or those sold under the KELTAN™ tradename (available from Arlanxeo Performance Elastomers of Orange, Tex., USA). In non-limiting examples, suitable EPDM rubbers may exhibit one or more of the following properties:
1) a Mooney ML viscosity (1+4, 125° C.) of 50 MU and a composition of 64 wt % ethylene, 4.2 wt % ethylidenenorbornene, and 75 phr extender oil;
2) a Mooney ML viscosity (1+4, 125° C.) of 52 MU and a composition of 62 wt % ethylene, 0.7 wt % vinyl norbornene, and 100 phr extender oil;
3) a Mooney ML viscosity (1+4, 125° C.) of 147 MU and a composition of 54 wt % ethylene, 10 wt % ethylidenenorbornene, and 0 phr extender oil;
4) a Mooney ML viscosity (1+4, 125° C.) of 25 MU and a composition of 77 wt % ethylene, 0.9 wt % vinyl norbornene, and 0 phr extender oil;
5) a Mooney ML viscosity (1+4, 125° C.) of 48 MU and a composition of 61 wt % ethylene, 4 wt % ethylidenenorbornene, and 100 phr extender oil (e.g., KELTAN™ 5469Q);
6) a Mooney ML viscosity (1+4, 125° C.) of 37 MU and a composition of 68 wt % ethylene, 9.4 wt % ethylidenenorbornene, and 100 phr extender oil (e.g., KELTAN™ 4969Q); and
7) a Mooney ML viscosity (1+4, 125° C.) of 52 MU and a composition of 63.2 wt % ethylene, 4.5 wt % ethylidenenorbornene, and 100 phr extender oil (e.g., KELTAN™ 5469).

Another suitable EPDM rubber is KELTAN™ 4869.

### Other Rubbers

The rubber may be halogenated or non-halogenated, for example, an elastomer including repeating units derived from at least one C₄ to C₇ isomonoolefin monomer and at least about 3.5 mol % of repeating units derived from at least one C₄ to C₇ multiolefin monomer.

In one example, the rubber may be a nitrile rubber, such as an acrylonitrile copolymer rubber. Suitable nitrile rubbers comprise rubbery polymers of 1,3-butadiene and acrylonitrile having an acetonitrile content of about 20 wt % to about 50 wt %. Suitable nitrile rubbers may have a weight average molecular weight (M_{w}) of at least 50,000 g/mol, preferably from about 100,000 g/mol to about 1,000,000 g/mol. Commercially available nitrile rubbers suitable for the practice of the present TPE compositions are described in Rubber World Blue Book, 1980 Edition, Materials and Compounding Ingredients for Rubber, pages 386-406.

The term “butyl rubber” refers both halogenated and un-halogenated copolymers of isobutylene. Examples of copolymers of isobutylene include copolymers of isobutylene and isoprene, also known as isobutylene isoprene rubber (IIR), and copolymers of isobutylene and C₁₋₄ alkyl styrene, such as paramethyl styrene. Examples of halogenated butyl rubber include bromobutyl rubber and brominated copolymers of isobutylene and paramethyl styrene available under the trade name BIMSM™ available from ExxonMobil Chemical Company.

In embodiments where the butyl rubber includes an isobutylene-isoprene copolymer, the isobutylene-isoprene copolymer may include isoprene in a range from about 0.5 wt % to about 30 wt %, such from about 0.8 wt % to about 5 wt %, based on the entire weight of the copolymer with the remainder being isobutylene.

In embodiments where the butyl rubber includes an isobutylene-paramethyl styrene copolymer, the isobutylene-paramethyl styrene copolymer may include paramethyl styrene in a range from about 0.5 wt % to about 25 wt %, such as from about 2 wt % to about 20 wt %, such as from about 7 wt % to 12 wt %, based on the entire weight of the copolymer with the remainder being isobutylene. Suitable isobutylene-paramethyl styrene copolymers may be optionally halogenated (e.g., brominated) in a range from about 0 wt % to about 10 wt %, such as from about 0.3 wt % to about 7 wt %, such as from about 0.5 wt % to about 3.0 wt %. In particular examples, the rubber is a blend of EPDM terpolymer and a copolymer of isobutylene and C₁₋₄ alkyl styrene.

Butyl rubber can be obtained from a number of commercial sources as disclosed in the Rubber World Blue Book. For example, both halogenated and un-halogenated copolymers of isobutylene and isoprene are available under the trade name Exxon BUTYL™ available from ExxonMobil Chemical Company, halogenated and un-halogenated copolymers of isobutylene and paramethyl styrene are available under the trade name EXXPRO™ available from ExxonMobil Chemical Company, and star branched butyl rubbers are available under the trade name STAR BRANCHED BUTYL™ available from ExxonMobil Chemical Company. Halogenated and non-halogenated terpolymers of isobutylene, isoprene, and divinyl styrene are available under the trade name POLYSAR BUTYL™ available from Bayer of Leverkusen, Germany.

### Cyclic Olefin Copolymer (COC) or Hydrocarbon Resin

A TPE composition of the present disclosure may further include a COC or hydrocarbon resin, which may increase gas permeability when compared to similar TPE compositions.

Examples of suitable COCs comprise copolymers of cyclic monomers, such as, but not limited to, norbornene, tetracyclododecene, or other cyclic monomers. One example of a suitable COC comprises a copolymer of norbornene and ethylene. Suitable COCs may be fully hydrogenated, partially hydrogenated, or non-hydrogenated. Suitable COCs may be manufactured or synthesized by using a variety of techniques. For example, a COC may be formed by ring opening metathesis polymerization of a cyclic monomer. Examples of commercially available COCs that may be used in the TPE compositions disclosed herein include TOPAS™ (available from TOPAS Advanced Polymers of Frankfurt-Höchst, Germany), APEL™ (available from Mitsui Chemical of Tokyo, Japan), ARTON™ (available from JSR Corporation of Tokyo, Japan), and ZEONEX™ (available from Zeon Corporation of Tokyo, Japan).

Using the methods disclosed herein, a TPE composition having high gas permeability may be prepared by incorporating a COC and/or hydrocarbon resin. While not wishing to be bound by theory, it is believed that the presence of a COC and/or a hydrocarbon resin may disrupt the crystal structure of the thermoplastic polyolefin matrix, thereby generating a TPE with lower crystallinity but higher gas permeability when compared to TPE compositions absent a COC and/or hydrocarbon resin.

Further, by using the methods and formulations disclosed herein, a TPE composition having one or more of a low thermal conductivity, enhanced hardness, and high abrasion resistance may be prepared by incorporating a COC and/or a hydrocarbon resin.

COCs suitable for use in the TPE compositions as disclosed herein may exhibit one, two, or all three of the following characteristics:
1) a cyclic monomer content in a range from about 30 wt % to about 90 wt % based on the total weight of the COC;
2) a glass transition temperature (T_{g}) as determined by DSC (10° C./minute) of about 10° C. to about 190° C. such as about 60° C. to about 160° C.; and
3) a melt flow index (MFI) of about 1 mL/10 minutes to about 60 mL/10 minutes, such as about 4 mL/10 minutes to about 50 mL/10 minutes.

Hydrocarbon resins suitable for use in the TPE compositions as disclosed herein may exhibit one or both of the following characteristics:
1) a T_{g} (as determined by DSC (10° C./minute)) of about 10° C. to about 190° C. such as about 60° C. to about 160° C.; and
2) an MFI of about 1 mL/10 minutes to about 60 mL/10 minutes, such as about 4 mL/10 minutes to about 50 mL/10 minutes.

### Fillers

Fillers that can be used include reinforcing and non-reinforcing fillers. Examples of suitable fillers that can be utilized include, but are not limited to, clay, talc, silica, calcium carbonate, titanium dioxide, carbon black, a nucleating agent, mica, wood flour, other suitable organic or inorganic fillers, and any blend thereof. One example of a suitable filler is calcined aluminum silicate (e.g., ICECAP K™, available from Burgess Pigment Company of Sandersville, Ga., USA).

### Nucleating Agent

The term “nucleating agent” means any additive that produces a nucleation site for thermoplastic crystals to grow from a molten state to a solid, cooled structure. In other words, nucleating agents provide sites for growing thermoplastic crystals upon cooling the thermoplastic from its molten state.

The nucleating agent provides a plurality of nucleating sites for the thermoplastic component to crystallize when cooled. Surprisingly, this plurality of nucleating sites promotes even crystallization within the thermoplastic elastomer composition, allowing the composition to crystallize throughout an entire cross-section in less time and at higher temperature. This plurality of nucleating site produces a greater amount of smaller crystals within the thermoplastic elastomer composition, which require less cooling time.

This even cooling distribute enables the formation of extruded articles of the present TPE compositions having a thickness of about 2 mm or more, such as about 5 mm or more, about 10 mm or more, or about 15 mm or more. Extruded articles of the present TPE compositions can have thicknesses of about 20 mm or more and still exhibit effective cooling (e.g., cooling from an outer surface of the cross-section to an inner surface of the cross-section) at extrusion temperatures without sacrificing mechanical strength. Such extrusion temperatures are at or above the melting point of the thermoplastic component. Illustrative nucleating agents include, but are not limited to, dibenzylidene sorbitol based compounds, sodium benzoate, sodium phosphate salts, as well as lithium phosphate salts. For example, the nucleating agent may include sodium 2,2′-methylene-bis-(2,6-di-tert-butylphenyl)phosphate (e.g., HYPERFORM™, available from Milliken & Company of Spartanburg, S.C., USA). Another specific nucleating agent is norbornane (bicyclo(2.2.1)heptane carboxylic acid salt, which is commercially available from CIBA Specialty Chemicals of Basel, Switzerland.

### Processing Oils/Plasticizers

Processing oils that can be used include mineral oils (such as Group 1 mineral oils or Group II mineral oils), petroleum-based oils, synthetic oils, low-molecular-weight aliphatic esters, ether ester, other suitable oils, or a combination thereof. These oils may also be referred to as plasticizers or extenders. Mineral oils may include aromatic, naphthenic, paraffinic, isoparaffinic oils, synthetic oils, and combinations thereof. The mineral oils may be treated or untreated. One example of a mineral oil that may be employed in the TPE compositions disclosed and described herein is PARAMOUNT™ 6001R available from Chevron Products Company of San Ramon, Calif., USA.

Many additive oils are derived from petroleum fractions, and have particular ASTM designations depending on whether they fall into the class of paraffinic, naphthenic, or aromatic oils. According to the American Petroleum Institute (API) classifications, base stocks are categorized in five groups based on their saturated hydrocarbon content, sulfur level, and viscosity. Group I oils and group II oils are derived from crude oil via processing, such as, but are not limited to, solvent extraction, solvent or catalytic dewaxing, and hydroisomerization, hydrocracking and isodewaxing, isodewaxing and hydrofinishing. Synthetic oils include alpha olefinic synthetic oils, such as liquid polybutylene. Additive oils derived from coal tar and pine tar can also be used. Examples of such oils include, but are not limited to, white oil produced from gas to liquid technology such as RISELLA™ X 415/420/430 (available from Shell of Houston, Tex., USA); PRIMOL™ 352, PRIMOL™ 382, PRIMOL™ 542, MARCOL™ 82, and MARCOL™ 52 (available from ExxonMobil Chemical Company); DRAKEOL™ 34 available from Penreco of Karns City, Pa.; or combinations thereof. Oils described in U.S. Pat. No. 5,936,028, which is incorporated herein by reference for U.S. patent practice, may also be employed.

Examples of suitable synthetic oils include polymers and oligomers of butenes such as, but not limited to, isobutene, 1-butene, 2-butene, butadiene, and mixtures thereof. These oligomers may be characterized by a number average molecular weight (Mₙ) of about 300 g/mol to about 9,000 g/mol, such as about 700 g/mol to about 1,300 g/mol. Optionally, these oligomers may include isobutenyl mer units. Exemplary synthetic oils include, but are not limited to, polyisobutylene, poly(isobutylene-co-butene), and mixtures thereof. Synthetic oils may also optionally include polylinear α-olefins, poly-branched α-olefins, hydrogenated polyalphaolefins, or mixtures thereof. Suitable synthetic oils may exhibit a viscosity of about 20 cp or more, such as about 100 cp or more or about 190 cp or more. Additionally or alternatively, the viscosity of these oils may be about 4,000 cp or less, such as about 1,000 cp or less. Useful synthetic oils can be commercially obtained under the trade names POLYBUTENE™ (available from Soltex of Houston, Tex., USA), PARAPOL™ (available from ExxonMobil Chemical Company), and IDOPOL™ (available from Ineos Olefins & Polymers, League City, Tex., USA). Oligomeric copolymers including butadiene are commercially available under the trade name RICON RESIN™ (available from Ricon Resins of Grand Junction, Colo., USA).

One of ordinary skill in the art will recognize which type of oil should be used with a particular rubber and be able to determine a suitable amount of oil to use. For example, a TPE composition may comprise about 5 parts by weight per 100 parts by weight (of the combined rubber and isotactic polypropylene components) (phr) to about 300 phr of the additive oil, such as from about 30 phr to 250 phr or from about 70 phr to 200 phr. Alternatively, the quantity of additive oil can be based on the total rubber content, and defined as the ratio, by weight, of additive oil to total rubber in the TPE, and that amount may in certain cases be the combined amount of processing oil (typically added during processing) and extender oil (typically added after processing). The ratio may range, for example, from about 0 to about 4.0/1. Other ranges, having any of the following lower and upper limits, may also be utilized: a lower limit of 0.4/1, or 0.6/1, or 0.8/1, or 1.0/1, or 1.2/1, or 1.5/1, or 1.8/1, or 2.0/1, or 2.5/1 and an upper limit (which may be combined with any of the foregoing lower limits) of 4.0/1, or 3.8/1, or 3.5/1, or 3.2/1, or 3.0/1, or 2.8/1. Larger amounts of additive oil can be used, although the deficit is often reduced physical strength of the composition, oil weeping, or both.

Polymeric processing additives may also optionally be added. Polymeric processing additives include both polymeric and oligomeric resins. Polymeric processing additives may comprise, for example, a hydrocarbon resin that had a very high MFI. Suitable polymeric resins include both linear and branched molecules that have an MFI of about 500 g/10 minutes or greater, such as about 750 g/10 minutes or greater, about 1000 g/10 minutes or greater, about 1200 g/10 minutes or greater, or about 1500 g/10 minutes or greater. Mixtures of various branched or various linear polymeric processing additives, as well as mixtures of both linear and branched polymeric processing additives may be used. Examples of useful linear polymeric processing additives include polypropylene homopolymers. Examples of useful branched polymeric processing additives include diene-modified polypropylene polymers. Thermoplastic elastomers that include similar processing additives are disclosed in U.S. Pat. No. 6,451,915, which is incorporated herein by reference with respect to its disclosure of thermoplastic elastomers and additives thereof.

A TPE composition may further optionally comprise a low-to-medium molecular weight (M_{w}, such as about 10,000 g/mol or less) organic ester and/or alkyl ether esters, thereby generating a TPE composition having a lower glass transition temperature (T_{g}). The addition of certain low to medium molecular weight organic esters and alkyl ether esters may also improve various low temperature properties, such as flexibility and strength, of a TPE composition. Surprisingly, TPE compositions that incorporate a low-to-medium molecular weight organic ester and/or alkyl ether ester also exhibit enhanced permeability and abrasion resistance. While not wishing to be bound by theory, it is believed that these advantageous effects are achieved by the partitioning of the ester into both the polyolefin and rubber phases of the TPE composition. Examples of suitable esters include monomeric and oligomeric aliphatic esters having a low weight average molecular weight (M_{w}), such as about 2000 g/mol or below or about 600 g/mol or below. Suitable esters may be compatible, or miscible, with both the polyolefin and rubber components of the compositions. Further examples of suitable low-to-medium molecular weight esters include, but are not limited to, monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof. More specific examples include, but are not limited to, diisooctyldodecanedioate, dioctylsebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof.

Other analogues expected to be useful in the present TPE compositions include alkyl alkylether monoadipates and diadipates, monoalkyl and dialkyl adipates, glutarates, sebacates, azelates, ester derivatives of castor oil or tall oil, and oligomeric monoesters and diesters or monoalkyl and dialkyl ether esters therefrom. Isooctyltallate and n-butyltallate may also be useful. Polymeric aliphatic esters and aromatic esters were found to be significantly less effective, and phosphate esters were for the most part ineffective.

These esters may be used alone in the compositions, or as mixtures of different esters, or they may be used in combination with conventional hydrocarbon oil diluents or processing oils (e.g., paraffin oil). A TPE composition may comprise from about 0.1 wt % to about 40 wt % based upon a total weight of the TPE composition of an ester plasticizer. Additionally or alternatively, a TPE composition may comprise about 250 phr or less, such as about 175 phr or less of an ester plasticizer. Examples of suitable ester plasticizers include, but are not limited to, isooctyltallate and n-butyl tallate. Such esters are available commercially as PLASTHALL™ available from Hallstar of Chicago, Ill., USA.

Suitable hydrocarbon resins include, for example, those produced from petroleum-derived hydrocarbons and monomers of feedstock including tall oil and other polyterpene or resin sources. The terms “hydrocarbon resin” or “resin molecule” are interchangeable as used herein. Hydrocarbon resins are generally derived from petroleum streams, and may be hydrogenated or non-hydrogenated resins. The hydrocarbon resins may be polar or non-polar. “Non-polar” means that the resin is substantially free of monomers having polar groups. Such hydrocarbon resins may include substituted or unsubstituted units derived from cyclopentadiene homopolymer or copolymers, dicyclopentadiene homopolymer or copolymers, terpene homopolymer or copolymer, pinene homopolymer or copolymers, C₅ fraction homopolymer or copolymer, C₉ fraction homopolymer or copolymers, alpha-methylstyrene homo or copolymers, or combinations thereof. Examples of suitable hydrocarbon resins include aliphatic hydrocarbon resins such as resins resulting from the polymerization of monomers consisting of olefins and diolefins and the hydrogenated derivatives thereof (e.g., ESCOREZ™ and OPPERA™ from ExxonMobil Chemical Company or PICCOTAC™ 1095 from Eastman Chemical Company of Kingsport, Tenn., USA) and alicyclic petroleum hydrocarbon resins and the hydrogenated derivatives thereof (e.g., ESCOREZ™ 5300 and 5400 series; EASTOTAC™ resins from Eastman Chemical Company). Other exemplary resins useful in the TPE compositions of the present disclosure include hydrogenated cyclic hydrocarbon resins (e.g., REGALREZ™ and REGALITE™ resins from Eastman Chemical Company). For example, a suitable hydrocarbon resin may have a Ring and Ball (R&B) softening point equal to or greater than about 80° C. Surprising enhancements in permeability and lower thermal conductivities are observed by incorporating hydrocarbon resins in the TPE compositions disclosed herein.

### Slip Agent

In addition to the rubber, thermoplastic resins, processing oils, and fillers, the present TPE compositions may optionally include a slip agent, in particular, in TPV compositions where the rubber is cured with a phenolic or peroxide-based cure system. Examples of suitable slip agents include, but are not limited to, siloxane based additives (e.g., polysiloxanes), ultra-high-molecular-weight polyethylene (“UHMWPE”), a blend of siloxane based additives (e.g., polysiloxanes) and UHMWPE, molybdenum disulfide molybdenum disulfide, halogenated and non-halogenated compounds based on aliphatic fatty chains, fluorinated polymers, perfluorinated polymers, graphite, and combinations thereof. Suitable slip agents are characterized by a molecular weight (M_{w}) compatible with their use in oil, paste, or powder form.

More specific examples of suitable slip agents useful in the TPE compositions include, but are not limited to, fluorinated or perfluorinated polymers, such as KYNAR™ (available from Arkema of King of Prussia, Pa., USA), DYNAMAR™ (available from 3M of Saint Paul, Minn., USA), molybdenum disulfide, compounds based on aliphatic fatty chains (which may be optionally halogenated), and polysiloxanes. A slip agent may be of the migratory or non-migratory type, preferably of the non-migratory type.

A polysiloxane comprising a migratory siloxane polymer may be a liquid at standard conditions of pressure and temperature. A suitable polysiloxane may be a high-molecular-weight polysiloxane, such as linear polydimethyl-siloxane (PDMS). Additionally, a suitable polysiloxane may exhibit a viscosity at room temperature of about 100 cSt to about 100,000 cSt, such as from about 1,000 cSt to about 10,000 cSt, or from about 5,000 cSt to about 10,000 cSt.

A polysiloxane may additionally contain R groups selected to achieve a desired cure mechanism. Typically, a condensation cure or addition cure is used. For condensation reactions, two or more R groups per molecule may be hydroxyl or hydrolysable groups, such as alkoxy group having up to 3 carbon atoms. For addition reactions, two or more R groups per molecule may be unsaturated organic groups, typically alkenyl or alkynyl groups, preferably having up to 8 carbon atoms. One suitable commercially available material useful as the first polysiloxane is XIAMETER™ PMX-200 Silicone Fluid available from The Dow Chemical Company, Midland, Mich., USA. In embodiments wherein a polysiloxane is employed, the TPE compositions described herein may comprise about 0.2 wt % to about 20 wt %, such as from about 0.5 wt % to about 15 wt % or from about 0.5 wt % to about 10 wt % polysiloxane.

In embodiments comprising a non-migratory polysiloxane, the non-migratory polysiloxane may be bonded to a thermoplastic material. A non-migratory polysiloxane may be reactively dispersed in a thermoplastic material, which may be any homopolymer or copolymer of ethylene and/or α-olefins such as (but not limited to) propylene, 1-butene, 1-hexene, 1-octene, 2-methyl-1-propene, 3-methyl-1-pentene, 4-methyl-1-pentene, 5-methyl-1-hexene, and mixtures thereof. For example, a suitable thermoplastic material may be polypropylene homopolymer. Suitable methods of reactively bonding a polysiloxane to an organic thermoplastic polymer, such as a polyolefin, are disclosed in International Patent Publication Nos. WO2015/132190 and WO2015/150218, the entire contents of which are incorporated herein by reference with respect to methods disclosed for reactively bonding a polysiloxane to a thermoplastic polymer.

In embodiments comprising a non-migratory polysiloxane, the polysiloxane may comprise predominantly D and/or T units and some alkenyl functionalities, which assist in the reaction with the polymer matrix. A reaction product of polysiloxane and the polypropylene may have a number average molecular weight (Mₙ) of about 0.2 kg/mol to about 100 kg/mol and/or be at least about 1.1 times, preferably at least about 1.3 times the number average molecular weight (Mₙ) of the base polyorganosiloxane. A TPE composition described herein may contain about 0.2 wt % to about 20 wt %, such as about 0.2 wt % to about 15 wt % or about 0.2 wt % to about 10 wt % of a non-migratory polysiloxane. One example of a commercially available polysiloxane slip agent is HMB-0221 (available from The Dow Chemical Company).

A TPE composition as described herein may comprise one or more UHMWPE, for example, as an abrasion resistance-enhancing additive. A UHMWPE is a polyethylene polymer that comprises primarily ethylene-derived units and in some embodiments, the UHMWPE is a homopolymer of ethylene. Optionally, a UHMWPE may comprise additional α-olefin such as, but not limited to, 1-butene, 1-pentene, 1-hexene, 1-octene, 1-decene, 1-dodecene, 4-methyl-1-pentene, and 3-methyl-1-pentene. A suitable UHMWPE may have a weight average molecular weight (M_{w}) of about 1,500,000 g/mol or greater, about 1,750,000 g/mol or greater, about 1,850,000 g/mol or greater, or about 1,900,000 g/mol or greater. Examples of commercially available UHMWPE include MIPLEON™ XM-220, MIPLEON™ XM-330 (both available from Mitsui Chemical), Ticona GUR™ 4170 (available from Celanese, Dallas, Tex., USA), UTEC3040 (Braskem), LUBMER™ 5000 and LUBMER™ 5220 (both available from Mitsui Chemical).

Suitable UHMWPE may be in a powder or pellet form and/or have an average particle diameter of about 75 μm or less, about 70 μm or less, or about 65 μm or less. Additionally or alternatively, suitable UHMWPE may have an average particle diameter of 10 μm or greater, 15 μm or greater, 20 μm or greater, or 25 μm greater. Additionally or alternatively, suitable UHMWPE may have an average particle diameter of about 40 μm to about 75 μm, such as about 50 μm to about 70 μm, or about 55 μm to 65 μm. Additionally or alternatively, suitable UHMWPE may have an average particle diameter of about 10 μm to about 50 μm, such as about 15 μm to about 45 μm, about 20 μm to about 40 μm, or about 25 μm to about 30 μm.

A TPE composition may comprise about 5 wt % or greater, about 7 wt % or greater, about 9 wt % or greater, about 10 wt % or greater, or about 12 wt % or greater of UHMWPE. Additionally or alternatively, a TPE composition may comprise about 40 wt % or less, about 35 wt % or less, about 30 wt % or less, about 25 wt % or less, about 20 wt % or less, about 15 wt %, or about 12 wt % or less of UHMWPE. Additionally or alternatively, a TPE composition may comprise about 5 wt % to about 40 wt %, such as from about 5 wt % to 30 wt % or from about 7 wt % to about 15 wt % UMHWPE.

Other additives that may be useful in reducing the wear and abrasion resistance of the TPE compositions include, but are not limited to, perfluoropolyether (PFPE) synthetic oil (e.g., FLUOROGARD™ available from Chemours of Wilmington, Del., USA), polytetrafluoroethylene (PTFE), graphite, carbon fibers, carbon nanotubes, aramid fibers, and the like.

### Compatibilizers

A TPE composition disclosed herein may further include a compatibilizer, for example, to decrease the time for dispersion of the rubber as well as the decrease the particle size of the rubber domains, all while maintaining equivalent or better mechanical properties. Non-limiting examples of compatibilizers include styrenic block copolymers (e.g., styrene-butadiene-styrene and styrene-ethylene-butylene-styrene), copolymers of alpha-olefins (e.g., ethylene-octene, ethylene-butene, ethylene-propylene, and copolymers comprising olefin monomeric units and aromatic units (e.g., alpha-olefins with styrenics such as ethylene-styrene copolymers), and combinations thereof. The compatibilizers can be block copolymers, random copolymers, or pseudorandom copolymers.

In embodiments wherein the TPE compositions contains a diblock copolymer, the diblock copolymer may be present in the TPE composition at a range from about 0.5 wt % to about 30 wt %, such as from about 1 wt % to about 20 wt % or from about 3 wt % to about 10 wt %. In one example embodiment, a diblock copolymer may comprise isotactic polypropylene blocks and ethylene-propylene blocks. A block copolymer may contain isotactic polypropylene in a range from about 5 wt % to about 90 wt %. Similarly, block copolymer may contain ethylene (in the ethylene-propylene blocks) in a range from about 5 wt % to about 70 wt %. Exemplary polyolefin compatibilizers include, but are not limited to, INTUNE™ D5535, INTUNE™ D5545, and INTUNE™ 10510, INFUSE™ 9000, INFUSE™ 9007, INFUSE™ 9100, INFUSE™ 9107, each of which are available from The Dow Chemical Company.

Surprisingly, TPE compositions incorporating compatibilizers exhibit a more uniform dispersion of rubber domains within the thermoplastic elastomer composition thereby allowing the composition to be extruded into articles having a thickness of about 2 mm or greater, such as about 6 mm or greater, about 10 mm or greater, or about 15 mm or greater. Extruded articles comprising TPE compositions described herein may be formed at a thickness of about 8 mm or greater and still exhibit effective cooling (e.g., cooling from an outer surface of the cross-section to an inner surface of the cross-section) at extrusion temperatures without sacrificing mechanical strength.

### Curing Systems

In embodiments employing a cured rubber, the curing may be carried out by dynamic vulcanization. The term dynamic vulcanization refers to a vulcanization or curing process for a rubber contained in a blend with a thermoplastic resin, wherein the rubber is cross-linked or vulcanized under conditions of high shear at a temperature above the melting point of the thermoplastic. The rubber may be cured by employing a variety of curing agents. Any curing agent that is capable of curing or cross-linking the rubber employed in preparing the TPE compositions described herein may be used. Example cure systems include phenolic resin cure systems, hydrosilation cure systems, azide, and silane grafting/moisture cure systems. A curing agent may be introduced into the vulcanization process in a solution or as part of a dispersion. For example, a curative may be introduced to the vulcanization process as a curative-in-oil or a phenolic resin-in-oil, where the curative/resin is dispersed and/or dissolved in a processing oil. The processing oil used may be a mineral oil, such as an aromatic mineral oil, naphthenic oil, paraffinic mineral oils, or combination thereof.

A curing agent may comprise one or more peroxides, one or more phenolic resins, one or more free radical curatives, one or more hydrosilation curatives, an azide, or any other suitable curative. Depending on the rubber employed, certain curatives may be preferred. For example, where elastomeric copolymers containing units deriving from vinyl norbornene are employed, a peroxide curative may be preferred because the required quantity of peroxide will not have a deleterious impact on the engineering properties of the thermoplastic matrix of the thermoplastic elastomer. In other situations, however, it may be preferred not to employ peroxide curatives because they may, at certain levels, degrade the thermoplastic components (e.g., polypropylene) of the thermoplastic elastomer. In one example, the rubber employed with a phenolic curative comprises diene units deriving from 5-ethylidene-2-norbornene.

In any embodiment employing a cross-linked rubber, the rubber may be simultaneously cross-linked and dispersed as fine particles within a thermoplastic matrix, although other morphologies may also exist. Dynamic vulcanization may be effected by mixing the components at elevated temperature in conventional mixing equipment such as roll mills, stabilizers, BANBURY™ mixers, BRABENDER™ mixers, continuous mixers, mixing extruders, and the like. Methods for preparing TPE compositions are described in U.S. Pat. Nos. 4,311,628, 4,594,390, 6,503,984, and 6,656,693, which are incorporated herein by reference for U.S. patent practice with respect to the methods for preparing TPE compositions. Alternatively, methods employing low shear rates can also be used. Multiple-step processes can also be employed whereby ingredients, such as additional thermoplastic resin, can be added after dynamic vulcanization has been achieved, such as is disclosed in International Application No. WO 2005/028555, which is incorporated herein by reference with respect to processes disclosed for adding thermoplastic resin after dynamic vulcanization.

Useful phenolic cure systems are disclosed in U.S. Pat. Nos. 2,972,600; 3,287,440; 5,952,425; and 6,437,030, which are incorporated herein by reference with respect the disclosure regarding phenolic cure systems. A phenolic resin may be employed in an amount in a range from about 2 phr to about 10 phr (such as from about 3.5 phr to about 7.5 phr or from about 5 phr to about 6 parts phr). A phenolic resin curative may include a resole resin, which may be prepared by the condensation of alkyl substituted phenols or unsubstituted phenols with aldehydes, such as formaldehydes, in an alkaline medium or by condensation of bi-functional phenoldialcohols. An alkyl substituent of an alkyl-substituted phenol may contain 1 carbon atom to about 10 carbon atoms (e.g., dimethylolphenols or phenolic resins, substituted in para-positions with alkyl groups containing 1 carbon atom to 10 carbon atoms). For example, a blend of octylphenol-formaldehyde and nonylphenol-formaldehyde resins may be employed. Such a blend may comprise from about 25 wt % to about 40 wt % octylphenol-formaldehyde, such as from about 30 wt % to about 35 wt % octylphenol-formaldehyde and from about 75 wt % to about 60 wt % nonylphenol-formaldehyde, such as from about 70 wt % to about 65 wt % nonylphenol-formaldehyde. In a particular example, a blend may comprise about 33 wt % octylphenol-formaldehyde and about 67 wt % nonylphenol-formaldehyde resin, where each of the octylphenol-formaldehyde and nonylphenol-formaldehyde include methylol groups. This blend may be solubilized in processing oil (e.g., paraffinic oil) at about 30% solids without phase separation. The resultant blend is called Resin-in-Oil (RIO). Examples of phenolic resins-in-oil that may be used in the TPE compositions disclosed herein include SP-1044 and SP-1045 (available from the Schenectady Chemical Inc., SI Group, Schenectady, N.Y., USA).

A phenolic resin may be optionally used in combination with a halogen source, such as stannous chloride, acting as a cure accelerator. For example, anhydrous stannous chloride in polypropylene (herein referred to 45% SnCl₂ in polypropylene), which contains 45 wt % stannous chloride and 55 wt % of polypropylene having an MFI of 0.8 g/10 minutes, may be used. Other stannous chloride compositions may also be used. The stannous chloride can be employed in an amount of about 0.2 phr to about 10 phr, such as from about 0.3 phr to about 5 phr or from about 0.5 phr to about 3 phr.

Optionally, a phenolic resin may be used in combination with a metal oxide, such as zinc oxide, or reducing compound as a cure moderator. The zinc oxide can be employed in an amount of about 0.25 phr to about 5 phr, such as from about 0.5 phr to about 3 phr or from about 1 phr to about 2 phr.

In any embodiment, phenolic resin may be employed in conjunction with both stannous chloride and zinc oxide, in the ranges as disclosed above.

In embodiments utilizing hydrosilation cure systems, a silicon hydride reducing agent compound having at least two Si—H group may be employed in conjunction with a suitable catalyst. Suitable silicon hydride reducing agent compounds may exhibit a molar equivalent of the silicon hydride groups per kilogram of the reducing agent of about 0.1 to about 100. In certain embodiments wherein a hydrosilation cure system is employed, the silicon hydride reducing agent compounds have a number average molecular weight (Mₙ) in a range from about 0.2 kg/mol to about 100 kg/mol. Suitable silicon hydride reducing agent compounds may be characterized by a weight average molecular weight (M_{w}) of about 200 g/mol to about 800,000 g/mol, such as from about 300 g/mol to about 300,000 g/mol, or about 400 g/mol to about 150,000 g/mol. Exemplary silicon hydride reducing agent compounds include polysiloxanes and polyorganosiloxanes such as, but not limited to, methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)-benzene, and mixtures thereof. Additional examples of multi-functional organosilicon compounds include polymethylhydrodimethylsiloxane copolymers terminated with trimethylsiloxy groups or alkoxy groups and polymethylhydrosiloxane polymers similarly terminated. For example, the silicon hydride reducing agent compound may be a trimethylsilyl-terminated methyl hydrogen methyloctyl siloxane. One example of a silicon hydride compound includes XIAMETER™ OFX-5084 available from The Dow Chemical Company. Other specific examples of hydrosilating agents, which may also be referred to as HQ-type resins or hydride-modified silica Q resins, include those compounds that are commercially available under the trade name MQH-9™ (available from Clamant, Muttenz, Switzerland), which is a hydride-modified silica Q resin characterized by a molecular weight of 900 g/mol and an activity of 9.5 equivalents/kg; HQM105™ (available from Gelest, Morrisville, Pa., USA), which is a hydride modified silica Q resin characterized by a molecular weight of 500 g/mol and an activity of 8-9 equivalents/kg; and HQM107™ (available from Gelest), which is a hydride-modified silica Q resin characterized by a molecular weight of 900 g/mol and an activity of 8-9 equivalents/kg.

A silicon hydride reducing agent compound may be employed in an amount of about 0.5 phr to about 5.0 phr, such as from about 1.0 phr to about 4.0 phr or from about 2.0 phr to about 3.0 phr.

Surprisingly, a silicon hydride reducing agent compound may also act as an effective abrasion resistance-enhancing agent or slip agent.

Useful catalysts include those compounds or molecules that can catalyze the hydrosilation reaction between a reactive silicon hydride-containing moiety or substituent and a carbon-carbon bond such as a carbon-carbon double bond. Optionally, suitable catalysts may be soluble in the reaction medium. Suitable catalysts include, but are not limited to, transition metal compounds that include a Group VIII metal. Exemplary Group VIII metals include palladium, rhodium, germanium, and platinum. A catalyst may include about 0.5 parts per million parts by weight of rubber (pmr) to about 20.0 pmr metal, such as from about 1.0 pmr to about 5.0 pmr or from about 1.0 pmr to about 2.0 pmr. Exemplary catalyst compounds include, but are not limited to, chloroplatinic acid, elemental platinum, chloroplatinic acid hexahydrate, complexes of chloroplatinic acid with sym-divinyltetramethyldisiloxane, dichloro-bis(triphenylphosphine) platinum (II), cis-dichloro-bis(acetonitrile) platinum (II), dicarbonyldichloroplatinum (II), platinum chloride, and platinum oxide, zero valent platinum metal complexes such as Karstedt's catalyst, solid platinum supported on a carrier (such as alumina, silica or carbon black), platinum-vinylsiloxane complexes (e.g., Ptₙ(ViMe₂SiOSiMe₂Vi)ₙ and Pt[(MeViSiO)₄]ₘ), platinum-phosphine complexes (e.g., Pt(PPh₃)₄ and Pt(PBU₃)₄), and platinum-phosphite complexes (e.g., Pt[P(OPh)₃]₄ and Pt[P(OBu)₃]₄), wherein Me represents methyl, Bu represents butyl, Vi represents vinyl and Ph represents phenyl, and n and m represent integers. Other catalyst compounds include RhCl(PPh₃)₃, RhCl₃, Rh/Al₂O₃, RuCl₃, IrCl₃, FeCl₃, AlCl₃, PdCl₂.2H₂O, NiCl₂, TiCl₄, and the like.

Optionally, a catalyst may be employed in conjunction with a catalyst inhibitor. Inhibitors may be particularly advantageous in embodiments where thermoplastic elastomers are prepared using dynamic vulcanization processes. Useful inhibitors include those compounds that stabilize or inhibit rapid catalyst reaction or decomposition, such as olefins that are stable above 165° C. One specific non-limiting example of a suitable catalyst inhibitor is 1,3,5,7,-tetravinyltetramethylcyclotetrasiloxane.

Those of ordinary skill in the art will be able to readily select an appropriate amount of hydrosilating agent to effect a desired cure. The amount of hydrosilating agent employed may be expressed in terms of the ratio of silicon hydride equivalents (e.g., the number of silicon hydride groups) to the equivalents of vinyl double bonds (e.g., the number of diene-derived units on the polymer). For example, the ratio of equivalents of silicon hydride to equivalents of vinyl bonds on the rubber may be about 0.7:1 to about 10:1, such as about 0.95:1 to about 7:1, about 1:1 to about 5:1, or about 1.5:1 to about 4:1.

In embodiments employing a moisture cure/silane graft curing system, a moisture-curable silane compound may be employed in conjunction with a moisture source. Examples of suitable moisture sources include, but are not limited to, steam, hot water, cold water, and ambient moisture. The silane compound may be grafted onto a polyethylene resin by reactive extrusion, and the graft resin may be contacted with a moisture-curing catalyst. One example of a moisture-cure catalyst is DYNASYLAN™ SILFIN 63 available from Evonik of Parsippany, N.J., USA.

In embodiments utilizing free-radical vulcanization, a free-radical vulcanizating agent may be employed. A peroxide, for example an organic peroxide, may be used. Examples of organic peroxides include, but are not limited to, di-tert-butyl peroxide, dicumyl peroxide, t-butylcumyl peroxide, alpha-bis(tert-butylperoxy)diisopropyl benzene, 2,5-dimethyl-2,5-di(t-butylperoxy)hexane (DB PH), 1,1-di(tert-butylperoxy)3,3,5-trimethyl cyclohexane, n-butyl-4,4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Diaryl peroxides, ketone peroxides, peroxydicarbonates, peroxyesters, dialkyl peroxides, hydroperoxides, peroxyketals, and mixtures thereof may also be used. The peroxide may be diluted in a processing oil, such as a low aromatic/sulfur content oil, and be used to produce the TPE compositions described herein.

A free-radical vulcanizing agent may be used in conjunction with a coagent. Useful coagents include high-vinyl polydiene or polydiene copolymer, triallylcyanurate, triallyl isocyanurate, triallyl phosphate, sulfur, N-phenyl bis-maleamide, divinyl benzene, trimethylol propane trimethacrylate, tetramethylene glycol diacrylate, trifunctional acrylic ester, dipentaerythritolpentacrylate, polyfunctional acrylate, retarded cyclohexane, dimethanol diacrylate ester, polyfunctional methacrylates, acrylate and methacrylate metal salts, multi-functional acrylate esters, multi-functional methacrylate esters, or a combination thereof, or oximers such as quinone dioxime.

### Methods of Making TPE Compositions

One example of a method of making TPE compositions includes introducing an elastomer to an extrusion reactor; introducing a thermoplastic resin to the extrusion reactor; introducing a filler, an additive, or a combination of filler and additive to the extrusion reactor; introducing a first amount of processing oil to the extrusion reactor at a first oil injection location; introducing a curative to the extrusion reactor at a location that is downstream of the first or second oil injection location (if second amount of oil injection is applicable); introducing a second amount of processing oil to the extrusion reactor at a second oil injection location, where the second oil injection location is downstream of the location where the curative is introduced to the extrusion reactor; and cross-linking the elastomer with the curative in the presence of the thermoplastic resin to form the TPE composition, wherein the TPE composition comprises a rubber phase that is dispersed and at least partially cross-linked within a continuous thermoplastic matrix. TPE compositions employing no cross-linking may be prepared by this method as well, omitting the step of introducing a curative and subsequent cross-linking.

In any TPE composition, the rubber phase may be partially or fully/completely cured. The degree of cure can be measured by determining the amount of rubber that is extractable from the thermoplastic elastomer by using cyclohexane or boiling xylene as an extractant. This method is disclosed in U.S. Pat. No. 4,311,628, which is incorporated herein by reference for U.S. patent practice. For example, the rubber in a TPE composition may have a degree of cure where not more than about 5.9 wt %, such as not more than about 5 wt %, not more than about 4 wt %, or not more than about 3 wt % is extractable by cyclohexane at 23° C. as described in U.S. Pat. Nos. 5,100,947 and 5,157,081, which are incorporated herein by reference with respect to its description of cure degree. In another example, the rubber may be cured to an extent where about 94% by weight of the rubber or more, such about 95 wt % or more, about 96 wt % or more, or about 97 wt % or more is insoluble in cyclohexane at 23° C. Alternatively or additionally, the rubber phase of a TPE composition may have a cross-link density of at least about 4×10⁻⁵ moles per milliliter of rubber, such as at least about 7×10⁻⁵ moles per milliliter of rubber, or at least about 10×10⁻⁵ moles per milliliter of rubber. See also “Cross-link Densities and Phase Morphologies in Dynamically Vulcanized TPEs,” by Ellul et al., RUBBER CHEMISTRY AND TECHNOLOGY, Vol. 68, pp. 573-584 (1995).

Whether the rubber is partially cured or fully cured, the compositions of this disclosure can be processed and reprocessed by conventional plastic processing techniques such as extrusion, injection molding, blow molding, and compression molding. The rubber within these thermoplastic elastomers can be in the form of finely divided and well-dispersed particles of vulcanized or cured rubber within a continuous thermoplastic matrix or matrix. In embodiments where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). For example, at least about 50%, such as about 60%, such as about 75% of the particles have an average diameter of about 5 μm or less, such as about 2 μm or less, such as about 1 μm or less.

According to the present disclosure, TPE compositions may exhibit one, some, or all of the following characteristics:
1) about 5 wt % to about 70 wt % of rubber, such as about 10 wt % to about 30 wt %, based upon the total weight of the TPE composition;
2) about 20 wt % to about 80 wt %, such as about 30 wt % to about 70 wt % of a thermoplastic polyolefin;
3) about 0.1 wt % to about 30 wt %, such as about 1 wt % to about 10 wt % of a cyclic olefin copolymer;

4) about 0.1 wt % to about 30 wt %, such as about 1 wt % to about 10 wt % of a hydrocarbon resin;
5) about 0.1 wt % to about 30 wt %, such as about 0.5 wt % to about 10 wt % of a polyolefin compatibilizer, preferably a block copolymer;
6) about 0.1 wt % to about 30 wt %, such as about 1 wt % to about 10 wt %, of a slip agent;
7) for phenolic cure systems, a phenolic cure agent in a suitable amount to partially or fully cross-link the rubber;
8) for hydrosilation cure systems, a hydrosilating agent present in the ratio of equivalents of Si—H groups of silicon hydride compounds to equivalents of vinyl bonds (carbon-carbon double bonds) of the rubber is from about 0.7:1 to about 10:1, about 0.95:1 to about 7:1, 1:1 or greater, s from 1:1 to 5:1; 2:1 or greater, or from 2:1 to 4:1;
9) about 1 phr to about 250 phr of a processing oil which is compatible with both the rubber and polyolefin;
10) about 1 wt % to about 40 wt % of a processing oil;
11) a carbon dioxide gas permeability of about 6 barrers or more, such as about 20 barrers or more, about 30 barrers or more, or about 40 barrers or more;
12) a Shore A hardness of about 60 or more, such as about 70 Shore A to about 90 Shore A;
13) a Shore D hardness of about 60 or less, such as about 20 Shore D to about 60 Shore D, or about 30 Shore D to about 50 Shore D;
13) an abrasion loss of about 100 mg/1000 cycle or less, such as an abrasion resistance of about 80 mg/1000 cycle or less, or such as an abrasion loss of about 60 mg/1000 cycle or less;
14) a thermal conductivity of about 0.30 W/m·K or less, such as about 0.2 W/m·K or less or about 0.18 W/m·K or less;
15) a tensile stress @ 7% of about 6 MPa or more, such as about 9 MPa or more;
16) a Young's Modulus of about 250 MPa or more, such as about 300 MPa or more or about 350 MPa or more;
17) a tensile strength at yield of about 5 MPa or more, such as from about 8 MPa to about 23 MPa, or about 9 MPa or more, such as about 11 MPA to about 15 MPa;
18) a tensile strain at yield of a tensile strain at yield ranging from a low of about 5%, about 15%, or about 25% to a high of about 100% or about 200%; and
19) a creep strain of about 100% or less, such as about 40% or less or about 10% or less.

Advantageously, the TPE compositions as prepared herein may have abrasion resistance provided by hydrosilation cure without any additional anti-friction slip agents or provided by phenolic cure and a siloxane-based or ultra-high-molecular-weight a slip agent without any other anti-friction fillers/agents.

### Fiber-Reinforced Spoolable Pipes

The TPE compositions described and disclosed herein may be used to form articles made by extrusion and/or co-extrusion, blow molding, injection molding, thermo-forming, elasto-welding, compression molding, 3D printing, pultrusion, and other fabrication techniques. For example, the TPE compositions may be used to form flexible pipes, tubing, hoses, and flexible structures, such as flexible pipes, flow lines, and flexible umbilicals used in transporting fluids in petroleum production. The flexible structures can transport hydrocarbons extracted from an offshore deposit and/or can transport water, heated fluids, and/or chemicals injected into the formation in order to increase the production of hydrocarbons. In a particular non-limiting example, the TPE compositions disclosed herein may be used to form the outer covering of a thermoplastic composite pipe.

Fiber-reinforced spoolable pipes having one or more layers made from a thermoplastic elastomer (TPE) composition and are provided. A TPE composition may include a dispersed, rubber component, which may be cross-linked or non-cross-linked; and a thermoplastic component; from 0.1% to 30% of a cyclic olefin copolymer. A fiber-reinforced spoolable pipe may include at least one layer comprising a TPE composition having a carbon dioxide gas permeability of at least about 40 barrers. In a particular example, a TPE composition may include a thermoplastic polyolefin, a rubber phase, and 0.1 wt % to 30 wt % of a slip agent. In yet another example, a TPE composition may include a thermoplastic polyolefin, a rubber, and a polymethylhydrosiloxane-based reducing agent with at least two silicon hydride groups.

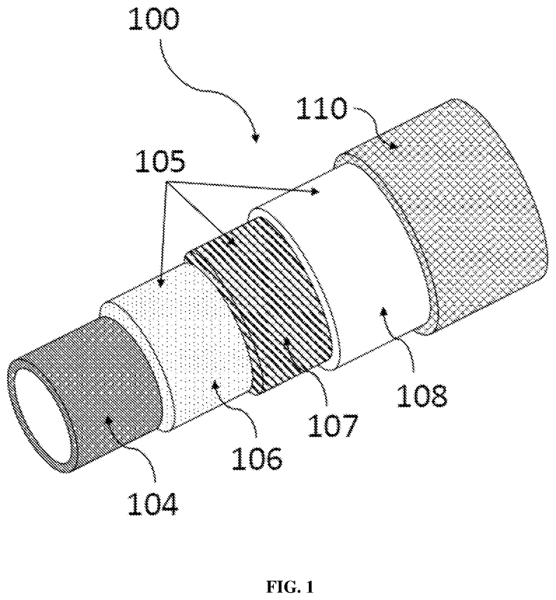

FIG. 1 is a schematic diagram of certain embodiments of a fiber-reinforced spoolable pipe 100 that may be used as flexible structure 100 of FIG. 1. One or more of the layers of the multilayer flexible structure 100 may be comprised of the present TPE compositions.

The fiber-reinforced spoolable pipe 100 is formed of a pipe body composed of multiple layers and one or more end fittings. The pipe body is typically formed as a composite of layered materials that form a fluid and pressure-containing conduit. The fiber-reinforced spoolable pipe 100 may bend without impairing the pipe's functionality over its lifetime. The fiber-reinforced spoolable pipe 100 is exposed to various loads, such an internal pressure in the interior of the fiber-reinforced spoolable pipe 100, external pressure of the outside seawater, and tension and weight of the fiber-reinforced spoolable pipe 100.

The TPE compositions described herein may be extruded as a single layer or extruded as tapes and wrapped around an interior pipe layer for use in the manufacture of one or more layers of the fiber-reinforced spoolable pipe 100. The present TPE compositions do not require the foaming of polymers to achieve low thermal conductivity before extruding it as a single layer. Present TPE compositions provide one or more layers of the fiber-reinforced spoolable pipe 100 with one or more of high gas permeability, low thermal conductivity, and high abrasion resistance, which may be extruded as a single layer.

The various arrangement of layers of a fiber-reinforced spoolable pipe are well known, and include those, for example, as disclosed in U.S. Pub. No. 20190162335, which is incorporated herein by reference with respect to the structure of the flexible pipes it describes. For example, FIG. 1 depicts a fiber-reinforced spoolable pipe into which the TPE compositions disclosed herein may incorporated. Fiber-reinforced spoolable pipe 100 includes barrier layer (often called “pressure sheath”) 104. Barrier layer 104 includes an outer surface and an inner surface that defines an inner diameter. Barrier layer 104 is a fluid barrier layer for transporting fluid and acts as a barrier to prevent the fluid from escaping the interior of barrier layer 104. A barrier layer may comprise HDPE, cross-linked polyethylene, PVDF, polyamide, polyethylene terephthalate, polyphenylene sulfide, polypropylene, or any blend thereof. The inner diameter of the fiber-reinforced spoolable pipe may have a thickness of about 50 mm to about 600 mm, such as from about 125 mm to about 600 mm, or about 125 mm to about 300 mm. The barrier layer can be formed in any desired way, with consideration as to the above noted description of the barrier. For example, the barrier layer may be produced by extrusion, providing continuous production thereof and may be cut to desired lengths.

One or more reinforcing layer(s) 105 disposed around barrier layer 104 includes sub-layers 106, 107, and 108, which are made from polymer matrix composites either glued or welded to the outer surface of the barrier layer and/or each other. Reinforcing layer(s) 105 may be built up from at least two separate laminates comprising unidirectional, continuous, or jointed fibers. In any embodiment, fibers may be carbon, thermoplastic, metal, glass, aramid, polyester, the like, or any combination thereof and may be embedded in the polymer matrix composite in at least a partially helical orientation relative to the longitudinal axis of fiber-reinforced spoolable pipe 100. A polymer matrix composite in which fibers may be embedded may comprise one or more of a polyamide, a polysulphone, a polyetherimide, a polyether sulfone, or, advantageously, may be a TPE composition as disclosed herein. A polymer matrix composite may comprise about 30 wt % to 80 wt % fiber, such as about 50 wt % to about 70 wt %. In particular, TPE compositions having low thermal conductivity and high gas permeability may be advantageous to use as a polymer matrix in the reinforcing layer(s) 105. Therefore, in one or more embodiments, one or more sub-layers 106, 107, 108 of a reinforcing layer(s) 105 may comprise a TPE composition as disclosed herein, having a thermal conductivity of 0.3 W/m·K or less, such as 0.2 W/m·K or less, or 0.18 W/m·K or less, to help maintain the high temperatures within the interior of barrier layer 104.

In one example, and with reference to FIG. 1, a fiber-reinforced spoolable pipe may be produced, for example, by winding reinforcing tape comprising the plastic matrix composite around the barrier layer 104 to form at least one ply of reinforcing tape wrapped helically in a first direction and at least one ply of reinforcing tape wrapped in a helical direction counter to the first direction. Each sub-layer in the reinforcing layer(s) may comprise a ply of helically wound tape, wherein at least one, preferably more or all, include fibers. Plies may be formed as tubular braids or as layers of counter wound helical wraps. The fibers may have, for example, a helical orientation of about 8° to about 86°, such as about 30° to about 70°, or about 40° to 70°, or about 50° to 60°. Preferably, the number of plies and lay angles of the combination of all braided and helically wound plies are selected such that the pipe is balanced and does not substantially twist when subject to internal pressure and tension loads. For example, reinforcing layer(s) 105 and sub-layers thereof 106, 107, 108 are preferably oriented in angles of about 35° C. to about 90° C., preferably 35° C. to about 70° C., relative to the longitudinal direction of fiber-reinforced spoolable pipe 100. For example, inner sub-layers (e.g., 106, 107) may be oriented at about 60° C. while outer sub-layers (e.g., 108) may be oriented alternatingly at about 45° C. Typical thickness of these layers ranges from about 20 mm to about 40 mm.

Outer layer (also called “outer jacket”) 110 protects reinforcing layer(s) 105 from wear, abrasion, chemical exposure, extreme temperatures, and the like. The TPE compositions disclosed herein, for example those exhibiting enhanced abrasion resistance and gas permeability, may be advantageously used in an outer layer, particularly in comparison to commonly used materials such as polyethylene and polyamides. Therefore, in certain embodiments, outer layer 110 comprises a TPE composition disclosed herein having high abrasion resistance, good flexibility, and good fatigue resistance at a low cost. In one or more embodiments, an outer layer may be comprised of a TPE composition having a thermal conductivity of about 0.3 W/m·K or less, such as about 0.2 W/m·K or less, or about 0.18 W/m·K or less, to help maintain the high temperatures within the interior of barrier layer 104. In certain embodiments, the TPE compositions described herein forming the outer layer have an abrasion resistance of about 60 mg/1000 cycle or less. A TPE composition may have abrasion resistance provided by hydrosilation cure without any additional anti-friction fillers/agents or provided by phenolic cure and a siloxane-based slip agent without any other anti-friction fillers/agents. In addition, anti-friction fillers may be further added to the TPE compositions to further provide abrasion resistance to outer layer 110. In certain embodiments, a TPE composition having a CO₂ gas permeability of about 40 barrers or more is used to form the outer layer 110 so that carbon dioxide and hydrogen sulfides may permeate out of outer layer 110 to reduce corrosion of reinforcing layer(s) 105.

In any embodiment, the TPE compositions useful as layers in fiber-reinforced spoolable pipes may include a filler or additive intended to reduce the coefficient of friction of the composition. According to certain embodiments, the TPE composition has a proportion by weight of filler of about 20% or less. This results in a good coefficient of friction and abrasion resistance of the adjacent layer against reinforcing layer, while still maintaining mechanical performance sufficient for the application.

Outer layer 110 may be applied to the one or more reinforcing layers in a variety of ways. For example, the outer layer materials may be applied by extrusion, spraying, dipping, tape winding (e.g., by using a tape placement method), shrink-wrapping, braiding, or the like, preferably by extrusion. In one embodiment, for example, a “thermoplastic tape placement” method may be employed whereby a thermoplastic tape and the substrate over which the tape is being applied are heated above their melting points. At the zone of contact, the tape is forced onto the substrate, for example, with a compaction roller. As a result, the tape and the substrate are fused together.

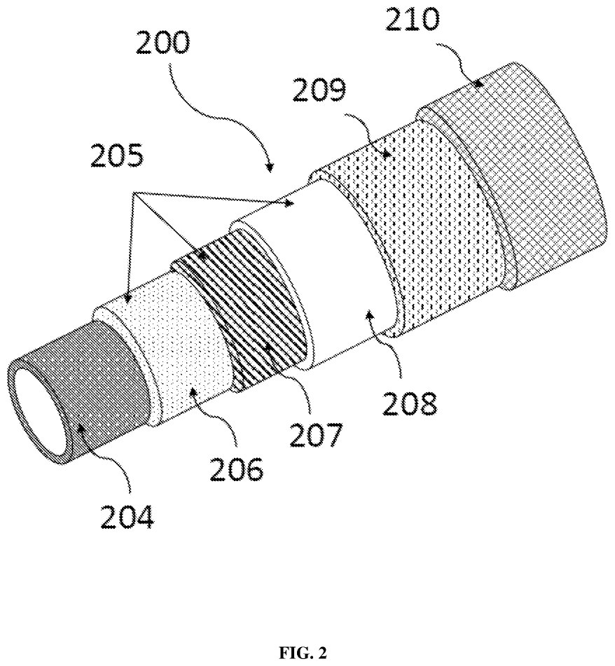

In any embodiment, a fiber-reinforced spoolable pipe may comprise a separate and optional insulating layer, such as shown in FIG. 2. Insulating layer 209 may surround one or more of barrier layer 204, one or more sub-layers 206, 207, 208 of reinforcing layer(s) 205, or outer layer 210. Insulating layer 209 provides thermal insulation to the interior of barrier layer 204 of fiber-reinforced spoolable pipe 200. For example, insulating layer 209 helps to maintain the high temperature within the interior of barrier layer 204 as it passes through the cold temperature of the outside seawater. If the fluid within the interior of barrier layer 204 falls or cools, such as due to the cold temperature of the outside seawater, paraffin may undesirably form and build up restricting or blocking the flow of fluid within the interior of barrier layer 204. In certain embodiments, insulating layer 209 acts as barrier against outside seawater intrusion and/or transferred fluid leakage. In certain embodiments, insulating layer 209 is comprised of TPE compositions disclosed herein have a thermal conductivity of about 0.3 W/m·K or less, such as about 0.2 W/m·K or less, or about 0.18 W/m·K or less, to help maintain the high temperatures within the interior of barrier layer 204. Trapped carbon dioxide and hydrogen sulfides with the interior of insulating layer 209 may undesirably corrode any metal in reinforcing layer(s) 205, effectively reducing the lifetime of fiber-reinforced spoolable pipe 200. In certain embodiments, the TPE compositions used to form insulating layer 209 have a carbon dioxide gas permeability of about 40 barrers or more, such that carbon dioxide and hydrogen sulfides may permeate out of insulating layer 209 to reduce the amount of carbon dioxide and hydrogen sulfides trapped within the interior of insulating layer 209 and therefore propensity for corrosion.

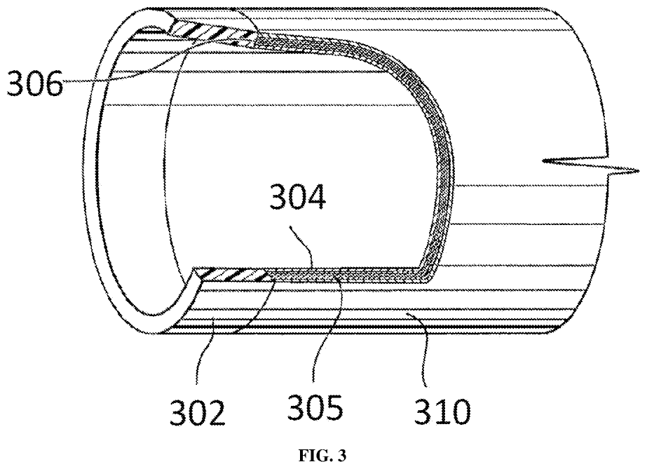

In any embodiment, a fiber-reinforced spoolable pipe may optionally comprise an end cap. For example, with reference to FIG. 3, a cap ring 302 may be installed at an end face 306 of a pipe. Cap ring 302 may protect and seal the otherwise exposed reinforcing layer 305 at the pipe end face 306. The cap ring 302, therefore, may be useful in applications where the pipe end face 304 is exposed, such as during handling and transportation and in final installations such as in pipe connections where the end face 306 is exposed. If employed in final installations, cap ring 302 serves to isolate the reinforcing layer at the pipe end face 306 from the pressurized liquid or gas. Cap ring 302 may be formed of a thermoplastic material and may be connected to the pipe end face 306 by fusion to the barrier layer 304, reinforcing layer 305, and/or outer layer 310. Fusing may be achieved using various methods such as, for example, butt fusion. The thermoplastic may be of the same type as that used in the pipe construction. The cap ring outer and inner diameters may match those of the pipe. The length of the cap ring is variable, but is typically in the range of about 10 mm to about 50 mm in length.

As an alternative to a cap ring, a layer of thermoplastic material may be applied to the exposed end surface between and overlapping the barrier layer and the outer layer. The layer of thermoplastic material may be applied in various ways, as by spray deposition, extrusion, dipping, or the like. The layer may be relatively thin (e.g., having a thickness of about 1 mm to about 4 mm).

The fiber-reinforced spoolable pipes disclosed herein may also include one or more couplings or fittings, for example, attached to or engage with one or more of the layers of the pipe and may act as a mechanical load transfer device or to obtain long lengths of fiber-reinforced flexible spoolable pipe. Couplings may engage one or both of the inner and outer layers of a fiber-reinforced spoolable pipe and may be made of metal, a polymer, or both. In addition, or alternatively, such couplings or fittings may provide a pressure seal or venting mechanism within or external to the fiber-reinforced spoolable pipe. For example, a coupling may be installed by fusion with the outer layer. In so doing, the outer layer, which includes a thermoplastic elastomer, may be heated to a temperature above the melting temperature of the thermoplastic and the coupling may be installed there over. In one embodiment, the coupling may include a liner of compatible thermoplastic, which is also heated to at least the melting temperature, such that the outer layer and the liner of the coupling fuse.

In certain embodiments, the excellent processability and low thermal conductivity of the TPE compositions that may be used to form an insulating layer permit an insulating layer to be extruded directly onto the outside of one or more of barrier layer 204, reinforcing layer(s) 205, and the outer layer 210 to reduce the number of manufacturing steps and cost when compared to conventional flexible pipes. In certain embodiments, an insulating layer 209 is extruded directly onto the outside of reinforcing layer(s) 205 and sealed to an end fitting so that sea water cannot flow into the interior and generate a corrosive environment for any metal of fiber-reinforced spoolable pipe 200. In certain embodiments, extrusion of insulating layer 209 comprised of present TPE compositions resists water penetration from the outside seawater more so than a helically wound tape.

In one or more embodiments, a fiber-reinforced spoolable pipe may also optionally include an inner layer within the barrier layer, which may be particularly useful in view of the external pressures experience by the pipe in offshore applications. In embodiments where it is included, an inner layer may be made of metal such as (but not limited to) carbon steel, stainless steel, stainless steel alloys (e.g., ATI 2003™, ATI2205™, or AL-6XN™, each available from ATI Houston, Tex., USA). In any embodiment, an inner layer may be an interlocked carcass layer, a flat helically wound layer, or a helically wound layer of round or shaped wire. An inner layer may prevent collapse of the barrier layer due to pipe decompression, external pressure, and the pressure imposed by the reinforcing layer(s).

The layers of the fiber-reinforced spoolable pipe comprise one or more layers, which, in some embodiments, may be combined. For example, in certain embodiments, the high carbon dioxide permeability, excellent abrasion resistance, and low thermal conductivity allows an external layer and an insulating layer to be combined and formed as a single layer. In any embodiment, layers of the fiber-reinforced spoolable pipe may be disposed in other orders. For example, an insulating layer may be disposed on a barrier layer and a reinforcing layer may be disposed on the insulating layer. The fiber-reinforced spoolable pipe may comprise additional layers or fewer layers. Each layer of the fiber-reinforced spoolable pipe may be partially bonded, fully bonded, or unbonded to an adjacent layer. Adjacent layers may be bonded by using adhesive, by applying heat, and/or by applying pressure to the layers. The fiber-reinforced spoolable pipe may be further combined with one or more other flexible pipes and/or umbilical lines (electrical, optical, hydraulic, control, etc.) into a single construction to form a multi-bore pipe.

The fiber-reinforced spoolable pipes disclosed herein have excellent properties for resisting the stress and strain of repeated spooling, particularly at strains greater than about 1%. For example, a fiber-reinforced spoolable pipe, for example with an inner diameter of about 150 mm to about 305 mm, may be flexible enough to be spooled onto a reel with a hub radius of about 4.5 m to about 8.5 m. When spooled, a fiber-reinforced spoolable pipe may have a radius of curvature from about 7 times to about 20 times the outer diameter of the pipe, which may range from about 5 cm to about 41 cm.

### EXAMPLE EMBODIMENTS

One example embodiment encompassed by the present disclosure is a spoolable pipe comprising a barrier layer formed around a longitudinal axis of the pipe, a reinforcing layer disposed around the barrier layer comprising a fiber material, and an outer layer, wherein at least one of the reinforcing layer and the outer layer comprises a thermoplastic elastomer (TPE) composition comprising a thermoplastic matrix and a rubber phase dispersed in the thermoplastic matrix and having a thermal conductivity of about 0.2 W/m·K or less. The embodiment may include one or more of the following Elements: Element 1: the spoolable pipe, wherein the reinforcing layer comprises a first ply of reinforcing tape helically wrapped in a first helical direction about the barrier layer and a second ply of reinforcing tape helically wrapped about the first ply of reinforcing tape in a second helical direction counter to the first helical direction, and wherein the reinforcing layer is at least partially bonded to an outer surface of the barrier layer; Element 2: the spoolable pipe, wherein the TPE composition further exhibits at least one of the following properties at 23° C.: (b) a tensile modulus of at least about 50 MPa; (c) a compressive strength of at least about 10 MPa; and (d) a specific heat capacity of 1300 J/kg·K or more; Element 3: the spoolable pipe, wherein the TPE composition comprises a rubber that is at least partially cross-linked; Element 4: the spoolable pipe, wherein the TPE composition comprises a rubber that is not cross-linked; Element 5: the spoolable pipe, wherein the outer layer is disposed around the reinforcing layer in one or more of the following manners: extruded onto the reinforcing layer, sprayed onto the reinforcing layer, applied as a dipped coating around the reinforcing layer, wound as a tape around the reinforcing layer, shrink-wrapped around the reinforcing layer, and braided around the reinforcing layer; Element 6: the spoolable pipe, wherein the outer layer is extruded onto the reinforcing layer; Element 7: the spoolable pipe, wherein the outer layer is wound around the reinforcing layer using a tape placement method; Element 8: the spoolable pipe, wherein the thermoplastic matrix comprises a thermoplastic polyolefin; Element 9: the spoolable pipe, wherein the TPE composition further comprises about 0.1 wt % to about 30 wt % of a cyclic olefin copolymer; Element 10: the spoolable pipe, wherein the TPE compositions further comprises about 1 wt % to about 10 wt % of a siloxane-based slip agent; Element 11: the spoolable pipe, wherein the TPE composition further comprises a cure system selected from the group consisting of: a phenolic resin, a peroxide, a maleimide, a hexamethylene diamine carbamate, a silicon-based curative, a metal oxide, a silane-based curative, and a sulfur-based curative; Element 12: the spoolable pipe, wherein the cure system is a moisture cure via silane graft system; Element 13: the spoolable pipe, wherein the cure system is a hydrosilation cure system; Element 14: the spoolable pipe, wherein the cure system is a phenolic cure system; Element 15: the spoolable pipe, wherein the TPE composition comprise about 5 wt % to about 50 wt % of the rubber phase and about 50 wt % to about 95 wt % of the thermoplastic phase; Element 16: Element 15, wherein the thermoplastic polyolefin comprises one or more of polypropylene, polyethylene, and butene; Element 17: Element 15, wherein the thermoplastic polyolefin comprises high-density polyethylene; Element 18: Element 16, wherein the polypropylene is a homopolymer, a random copolymer, or an impact copolymer; Element 19: Element 16, wherein the polypropylene is a high melt strength (HMS) long-chain branched (LCB) polypropylene homopolymer; Element 20: Element 16, wherein the polypropylene has one or both of an MFI of about 0.1 g/10 minutes to about 10 g/10 minutes and a molecular weight (M_{w}) of about 100,000 g/mol to about 1,000,000 g/mol; Element 21: Element 16, wherein the polypropylene has one or both of an MFI of about 0.1 g/10 minutes to about 10 g/10 minutes and a molecular weight (M_{w}) of about 100,000 g/mol to about 1,000,000 g/mol; Element 22: the spoolable pipe, wherein the rubber phase comprises one or more of an ethylene-propylene rubber, a poly-α-olefin elastomer, a nitrile rubber, and a butyl rubber; Element 23: Element 22, wherein the ethylene-propylene rubber comprises one or both of ethylidene norbornene and vinyl norbornene; Element 24: Element 22, wherein the poly-α-olefin elastomer comprises one or more of an ethylene-octene copolymer and an ethylene-butene copolymer; Element 25: Element 22, wherein the butyl rubber comprises one or more of isobutylene-isoprene rubber, brominated isobutylene-isoprene rubber, and isobutylene paramethylstyrene rubber; Element 26: the spoolable pipe, wherein the TPE composition has a Vicat softening point of about 100° C. to about 200° C.; Element 27: the spoolable pipe, wherein the TPE composition has an abrasion loss of not more than about 60 mg/1000 cycle-ranges; Element 28: the spoolable pipe, wherein the TPE composition has a Young's Modulus of about 100 MPa and a carbon dioxide permeability of at least about 25 barrers

$$( 2.5 \frac{{cm}_{STP}^{3} \cdot cm}{{cm}^{2} \cdot s \cdot cm Hg} ) ;$$

Element 29: the spoolable pipe, wherein the TPE composition further comprises one or more of a mineral oil, synthetic oil, a plasticizer, a filler, a metal oxide, and a thermal stabilizing agent; Element 30: Element 29, wherein the mineral oil comprises one or more of an aromatic oil, a naphthenic oil, a paraffinic oil, and an isoparaffinic oil; the paraffinic oil comprises one or more of a Group I oil, a Group II oil, and a Group III oil; and the synthetic oil comprises one or more of a polyalphaolefin, polyisobutylene, a polybutenes, and an alkylyl ester; Element 31: the spoolable pipe, wherein the TPE composition further comprises about 20 phr to about 100 phr of a polyolefin hardener, and wherein the polyisobutene is a light polyisobutene oil having a Mₙ from about 200 g/mol to about 6000 g/mol; Element 32: the spoolable pipe, wherein the TPE composition further comprises a plasticizer and wherein the plasticizer comprises one or more of a low-molecular-weight ester plasticizer and triisononyl trimellitate; Element 33: the spoolable pipe, wherein the TPE composition further comprises a filler and wherein the filler comprises one or more of calcium carbonate, clay, silica, talc, a metal oxide, carbon black, mica, and wood flour; and Element 34: the spoolable pipe, wherein the TPE composition comprises a low-molecular-weight ester. Examples of element combinations include, but are not limited to, Element 1 in combination with one or more of Elements 2-34; Element 2 in combination with one or more of Elements 3-34; Element 3 in combination with one or more of Elements 5-34; Element 4 in combination with one or more of Elements 5-34; Element 5 in combination with one or more of Elements 6-34; Element 6 in combination with one or more of Elements 8-34; Element 7 in combination with one or more of Elements 8-34; Element 8 in combination with one or more of Elements 9-34; Element 9 in combination with one or more of Elements 10-34; Element 10 in combination with one or more of Elements 11-34; Element 11 in combination with one of Elements 12-15; optionally in further combination with one or more of Elements 16-34; Element 12 (together with Element 11) in combination with one or more of Elements 15-34; Element 13 (together with Element 11) in combination with one or more of Elements 15-34; Element 14 (together with Element 11) in combination with one or more of Elements 15-34; Element 15 (and optionally Element 16 and/or 17) in combination with one or more of Elements 22-34; Element 16 (together with Element 15) in combination with one or more of Elements 18-34; Element 17 (together with Element 15) in combination with one or more of Elements 18-34; Element 18 (together with Element 15) in combination with one or more of Elements 19-34; Element 19 (together with Element 15) in combination with one or more of Elements 20-34; Element 20 (together with Element 15) in combination with one or more of Elements 21-34; Element 21 (together with Element 15) in combination with one or more of Elements 22-34; Element 22 (optionally in combination with Element 23 and/or Element 24) in combination with one or more of Elements 25-34; Element 23 (together with Element 22) in combination with one or more of Elements 24-34; Element 24 (together with Element 22) in combination with one or more of Elements 15-34; Element 25 (together with Element 22) in combination with one or more of Elements 26-34; Element 26 in combination with one or more of Elements 27-34; Element 27 in combination with one or more of Elements 28-34; Element 28 in combination with one or more of Elements 29-34; Element 29 (and optionally Element 30) in combination with one or more of Elements 31-34; Element 31 in combination with one or more of Elements 32-34; Element 32 in combination with one or both of Elements 33-34; Element 33 in combination with Element 34; Element 9 in combination with Element 27; Element 9 in combination with Element 28; and Element 9 in combination with Element 27 and 28; Element 10 in combination with Element 26; Element 9 in combination with Element 24; Element 9 in combination with Element 24 and 27; Element 9 in combination with Element 10 and Element 17; Element 10 in combination with Element 17; Element 12 in combination with Element 27; Element 9 in combination with Element 10, Element 17, and Element 27; Element 10 in combination with Element 17 and Element 27; Element 9 in combination with Element 10 and Element 19; and Element 9 in combination with Element 10, Element 19, and Element 28.

Another example embodiment includes a spoolable pipe comprising a barrier layer formed around a longitudinal axis of the pipe, a reinforcing layer disposed around the barrier layer comprising a fiber material, an outer layer, and an insulating layer, the insulating layer comprising a thermoplastic elastomer (TPE) composition comprising a thermoplastic matrix and a rubber phase dispersed in the thermoplastic matrix and having a thermal conductivity of about 0.2 W/m·K or less. Optionally, one or more of the following Elements may be combined with the embodiment: Elements 8-34; Element 35: the spoolable pipe, wherein the TPE composition exhibits a long-term temperature withstand capability of at least about 130° C.; Element 36: the spoolable pipe, wherein the TPE composition comprises hollow microspheres; Element 37: the spoolable pipe, wherein the insulating layer is disposed around the outer layer in one or more of the following manners: extruded onto the outer layer, sprayed onto the outer layer, applied as a dipped coating around the outer layer, wound as a tape around the outer layer, shrink-wrapped around the outer layer, and braided around the outer layer; Element 38: the spoolable pipe, wherein the insulating layer is extruded onto the outer layer; and Element 39: the spoolable pipe, wherein the insulating layer is wound around the outer layer using a tape placement method. Examples of element combinations include, but are not limited to, Element 8 in combination with one or more of Elements 10, 11, 15-17, 19, 27-29, and 33-39; Element 10 in combination with one or more of Elements 11, 15-17, 19, 27-29, and 33-39; Element 11 in combination with one or more of Elements 15-17, 19, 27-29, and 33-39; Element 15 in combination with one or more of Elements 16-17, 19, 27-29, and 33-39; Element 16 in combination with one or more of Elements 17, 19, 27-29, and 33-39; Element 17 in combination with one or more of Elements 19, 27-29, and 33-39; Element 19 in combination with one or more of Elements 27-29, and 33-39; Element 27 in combination with one or more of Elements 28-29, and 33-39; Element 28 in combination with one or more of Elements 29, and 33-39; Element 29 in combination with one or more of Elements 33-39; Element 33 in combination with one or more of Elements 34-39; Element 34 in combination with one or more of Elements 35-39; Element 35 in combination with one or more of 36-39; Element 36 in combination with one or more of Elements 37-39; Element 37 in combination with Elements 38 or Element 39; Element 34 in combination with Element 35; Element 9 in combination with Element 27; Element 9 in combination with Element 28; and Element 9 in combination with Element 27 and 28; Element 10 in combination with Element 26; Element 9 in combination with Element 24; Element 9 in combination with Element 24 and 27; Element 9 in combination with Element 10 and Element 17; Element 10 in combination with Element 17; Element 12 in combination with Element 27; and Element 9 in combination with Element 10, Element 17, and Element 27; and Element 9 in combination with Element 10 and Element 19.

Yet another example embodiment includes a spoolable pipe comprising: a barrier layer formed around a longitudinal axis of the pipe, a reinforcing layer disposed around the barrier layer comprising a fiber material, an outer layer, and optionally an insulating layer, wherein at least one of the reinforcing layer, the outer layer, and the insulating layer comprises a thermoplastic elastomer (TPE) composition comprising a thermoplastic matrix and a rubber phase dispersed in the thermoplastic matrix and having a CO₂ permeability at 60° C. of at least about 6 barrers

$$( {6}^{- 9} \frac{{cm}_{STP}^{3} \cdot cm}{{cm}^{2} \cdot s \cdot cm Hg} ) .$$

Optionally, one or more of the following Elements may be combined with the embodiment: Elements 1-39; Element 40: the spoolable pipe, wherein the TPE composition has a carbon dioxide permeability of at least about 25 barrers

$$( {2.5}^{- 8} \frac{{cm}_{STP}^{3} \cdot cm}{{cm}^{2} \cdot s \cdot cm Hg} ) ;$$

and Element 41: the spoolable pipe, wherein the TPE composition has a carbon dioxide permeability of at least about 40 barrers

$$( {4}^{- 8} \frac{{cm}_{STP}^{3} \cdot cm}{{cm}^{2} \cdot s \cdot cm Hg} ) .$$

Examples of element combinations include, but are not limited to, Element 4 in combination with one or more of Elements 9, 10, 21, 40, and 41; Element 9 in combination with one or more of Elements 10, 21, 40, and 41; Element 10 in combination with one or more of Elements 21, 40, and 41; and Element 40 in combination with Element 41.

To facilitate a better understanding of the aspects of the present disclosure, the following examples of preferred or representative aspects are given. In no way should the following examples be read to limit, or to define, the scope of the disclosure.

### Examples

### Sample Preparation Using a BRABENDER™ Mixer

Thermoplastic elastomer preparation was carried out under nitrogen in a laboratory BRABENDER™ PLASTI-CORDER™ (model EPL-V5502). The mixing bowls had a capacity of 85 mL with the cam-type rotors employed. The plastic was initially added to the mixing bowl that was heated to 180° C. and at 100-rpm rotor speed. After plastic melting (2 minutes), the rubber, inorganic additives, and processing oil were packed into the mixer. After homogenization of the molten polymer blend (in 3 to 4 minutes, a steady torque was obtained), the curative was added to the mix, which caused a rise in the motor torque.

Mixing was continued for about 4 more minutes, after which the molten TPE was removed from the mixer, and pressed when hot between Teflon plates into a sheet which was cooled, cut-up, and compression molded at about 400° F. A Wabash press, model 12-1212-2 TMB was used for compression molding, with 4.5 inch by 4.5 inch by 0.06 inch mold cavity dimensions in a 4-cavity TEFLON™-coated mold. Material in the mold was initially preheated at about 400° F. (204.4° C.) for about 2 to 2.5 minutes at a 2-ton pressure on a 4 inch ram, after which the pressure was increased to 10-tons, and heating was continued for about 2 to 2.5 minutes more. The mold platens were then cooled with water, and the mold pressure was released after cooling (140° F.). Dog-bones were cut out of the molded (aged at room temperature for 24 hours) plaque for tensile testing (0.16 inch width, 1.1 inch test length (not including tabs at end)).

### Sample Preparation Using a Twin Screw Extruder (TSE)

The following description explains the process employed in the following samples unless otherwise specified. A co-rotating, fully intermeshing type twin screw extruder, supplied by Coperion Corporation of Ramsey, N.J., USA, was used following a method similar to that described in U.S. Pat. Nos. 8,011,913, 4,594,390, and US 2011/0028637 (excepting those altered conditions identified here), which are incorporated herein by reference for U.S. patent practice. Rubber was fed into the feed throat of a ZSK 53 extruder. The thermoplastic resin was also fed into the feed throat along with other reaction rate control agents, such as zinc oxide and stannous chloride if applicable. Fillers were also added into the extruder feed throat. Processing oil was injected into the extruder at two different locations along the extruder. The curative was injected into the extruder after the rubber, thermoplastics and fillers commenced blending and after the introduction of first processing oil (pre-cure oil). The curative may also be injected with the processing oil, which oil may or may not have been the same as the other oil introduced to the extruder. A second processing oil (post-cure oil) was injected into the extruder after the curative injection. Rubber cross-linking reactions were initiated and controlled by balancing a combination of viscous heat generation due to application of shear, barrel temperature set point, use of catalysts, and residence time.

In order to demonstrate the practice of the present disclosure, the following examples have been prepared and tested. The examples should not, however, be viewed as limiting the scope of the present disclosure. The Tables below set forth the ingredients and amounts (parts per hundred rubber, phr) employed in each sample and the results of physical testing of the compositions of the present disclosures and comparative examples. Those samples that correspond with the present disclosure are designated with “Ex.,” and those that are comparative are designated with the letter “C.”

### Comparative Examples C-1 and C-2

Comparative examples C-1 and C-2 are materials used as one or more layers in currently available flexible pipes for fluid transportation in petroleum production described in the “Articles” section. Comparative example C-1 is a polyamide resin under the product name PA11 BESNO P40 TL available from Arkema of King of Prussia, Pa., USA. Comparative example C-2 is a high-density polyethylene copolymer under the product name ELTEX™ TUB121 available from Ineos Olefins & Polymers. Comparative example C-1 and comparative example C-2 were tested on injection-molded samples. Table 1 sets forth the results of physical testing that was performed on each sample.

TABLE 1

| | C-1 | C-2 |
|---|---|---|
| | (Polyamide) | (Copolymer) |
| Stress @ 7%, MPa | 15.6 | 22.9 |
| Yield Strength, MPa | 25.3 | 23.2 |
| Yield Strain, % | 50.7 | 9.4 |
| CO₂ Gas Permeability, barrers @ 60° C. | 6.1 | 9.1 |
| Abrasion loss, mg/1000 cycle | 33.5 | 50.0 |
| Thermal conductivity, W/m · K | 0.248 | 0.381 |
| Creep strain (@ 23° C., 4 MPa) after 1 | 4 | 2 |
| week, % | | |

### Phenolic Cure, Hydrosilation Cure, and Moisture Cure of TPE Compositions

Comparative example C-3 is a TPE composition comprising a polypropylene thermoplastic and an EPDM rubber that was cured using a phenolic cure. Example 1 is a TPE composition comprising a polypropylene thermoplastic and an EPDM rubber that was cured using a hydrosilation cure.

Example 2 is a TPE composition comprising a high-density polyethylene thermoplastic and a vinyl-terminated methoxysilane grafted on an ethylene octene plastomer that was cured using a moisture cure. Comparative examples C-3 and Examples 1 and 2 were each prepared on a twin-screw extruder and were tested on compression molded plaque samples. Table 2 sets forth the ingredients and amounts (part by weight) employed used in each sample and the results of physical testing that was performed on each sample. The polypropylene is BRASKEM™ F008F, a high melt strength (HMS) polypropylene homopolymer having a melt flow rate of 0.8 g/10 minutes. The HDPE is a high-density polyethylene having an MFI of about 0.25 g/10 minutes, The reactive polysiloxane is XIAMETER™ OFX-5084, having the properties of 0.8% SiH, a flash point of >100° C., and a viscosity (glass capillary, 25° C.) of about 9-30 cSt. The antioxidant package is calcium stearate and IRGANOX™ B4329. Zinc oxide (ZnO) is KADOX™ 911, available from The Horsehead Holding Company, Pittsburgh, Pa., USA. The stannous chloride is 45 wt % in polypropylene having an MFI of 0.8 g/10 minutes. The phenolic resin in oil is HRJ-16261™ (Schnectady Chemical Inc., SI Group) in PARALUX™ 6001R oil.

TABLE 2

| | | |
|---|---|---|
| C-3 | Ex 1 | Ex 2 |

Formulation (phr)

| | | | |
|---|---|---|---|
| EPDM(E)-1 | 175 | | |
| EPDM(V)-1 | | 200 | |
| Ethylene-Octene Copolymer | | | 100 |
| (ENGAGE ™ 8150) | | | |
| Polypropylene (BRASKEM ™ F008F) | 451 | 515.43 | |
| HDPE (EXXONMOBIL ™ HD 7800P) | | | 170 |
| ZnO (KADOX ™ 911) | 2 | 2 | |
| 45% SnCl₂ in polypropylene | 1.67 | | |
| Phenolic resin in oil | 12.82 | | |
| Reactive Polysiloxane | | 2.5 | |
| (XIAMETER ™ OFX-5084) | | | |
| Platinum catalyst | | 0.007123 | |
| Moisture-cure catalyst | | | 3 |
| (DYNASYLAN ™ SILFIN 63) | | | |
| Water | | | 3 |
| Antioxidant (Calcium Stearate/ | | 1.59 | |
| IRGANOX ™ B4329) | | | |
| Process Oil (PARAMOUNT ™ 6001R) | 49.32 | 61 | 20 |

Properties of the Compositions

| | | | |
|---|---|---|---|
| Hardness, Shore D | 51 | 48 | 46 |
| Stress @ 7%, MPa | 9.7 | 9.9 | 11.0 |
| Young's Modulus, MPa | 366 | 370 | 566 |
| Yield Strength, MPa | 12.0 | 12.2 | 12.5 |
| Yield Strain, % | 29.4 | 27.1 | 34.4 |
| CO₂ Gas Permeability, barrers @ | 58 | 62 | 61 |
| 60° C. | | | |
| Abrasion loss, mg/1000 cycle-ranges | 110 | 57.5 | 57 |
| Thermal conductivity, W/m · K | 0.193 | 0.193 | 0.214 |
| Creep strain (@ 23° C., 4 MPa) after | 10 | 6 | 6 |
| 1 week, % | | | |

Both Example 1, based on hydrosilation cure, and Example 2, based on moisture cure, showed higher abrasion resistance, lower creep, and higher CO₂ gas permeability compared to comparative example C-1, which is based on phenolic cure. Example 2 employs a ratio of 1:3 of VNB-EPDM to polysiloxane/silicon hydride as a curative, which can act as both cure and a migratory slip agent to improve the abrasion resistance. Similarly, methoxysilane added in situ may provide abrasion resistance advantage. Both Example 1 and Example 2 showed significantly higher CO₂ gas permeability and lower thermal conductivity compared to comparative example C-1 and comparative example C-2 of Table 1.

The compositions shown in Example 1 and Example 2 have a high CO₂ gas permeability, good abrasion resistance, and good tensile properties, which may be particularly suitable for use as one or more layers in a fiber-reinforced spoolable pipes as disclosed herein. More specifically, the compositions of Examples 1 and 2 may be suited for use in a reinforcing layer, as an abrasion-resistant low-cost outer layer, and/or as an extrudable insulating layer (either as a single layer or tape).

### Phenolic Cure of TPE Compositions Including a Siloxane-Based Slip Agent

Comparative example C-4 is a TPE composition comprising a polypropylene thermoplastic and an EPDM rubber that was cured using a phenolic cure. Comparative example C-5 is a TPE composition comprising a HDPE thermoplastic and an EPDM rubber that was cured using a phenolic cure. Example 3 is a TPE composition comprising a polypropylene thermoplastic, an EPDM rubber, an ultra-high-molecular-weight siloxane, and a cyclic olefin copolymer that was cured using a phenolic cure. Example 4 is a TPE composition comprising a HDPE thermoplastic, an EPDM rubber, an ultra-high-molecular-weight siloxane and a cyclic olefin copolymer that was cured using a phenolic cure. Example 5 is a TPE composition comprising a HDPE thermoplastic, an ultra-high-molecular-weight siloxane, and an EPDM rubber that was cured using a phenolic cure. The TPE compositions of Examples 3-5 further comprises a siloxane-based slip agent. Comparative examples C-4 and C-5 and Examples 3-5 were each prepared on a BRABENDER™ mixer and were tested on compression molded plaque samples. Table 3 sets forth the ingredients and amounts (parts per weight) employed used in each sample and the results of physical testing that was performed on each sample. TOPAS™ 5013 is a COC having an MFI of 48 mL/10 minutes.

TABLE 3

| | | | | |
|---|---|---|---|---|
| C-4 | C-5 | Ex 3 | Ex 4 | Ex 5 |

Formulation (phr)

| | | | | | |
|---|---|---|---|---|---|
| EPDM(E)-1 | 175 | 175 | 175 | 175 | 175 |
| Polypropylene (BRASKEM ™ F008F) | 451 | | 385.6 | | |
| HDPE (EXXONMOBIL ™ HD 7800P) | | 451 | | 406 | 429 |
| Cyclic Olefin Copolymer (TOPAS ™ 5013) | | | 45.1 | 45.1 | |
| Slip Agent (PDMS in hPP - Dow Corning HMB-0221) | | | 22 | 22 | 22 |
| Filler (Burgess ICECAP K ™) | 42 | 42 | 42 | 42 | 42 |
| ZnO (KADOX ™ 911) | 2 | 2 | 2 | 2 | 2 |
| 45% SnCl₂ in polypropylene | 1.67 | 1.67 | 1.67 | 1.67 | 1.67 |
| Phenolic resin in oil | 12.82 | 12.82 | 12.82 | 12.82 | 12.82 |
| Polyalphaolefin Fluid (SPECTRASYN ™ 40) | | | | | 49.32 |
| Process Oil (PARAMOUNT ™ 6001R) | 49.32 | 49.32 | 49.32 | 49.32 | |

Properties of the Compositions

| | | | | | |
|---|---|---|---|---|---|
| Hardness, Shore D | 48 | 38 | 46 | 37 | 37 |
| Stress @ 7%, MPa | 10.7 | 7.5 | 10.6 | 7.1 | 7.0 |
| Young's Modulus, MPa | 437 | 308 | 522 | 318 | 299 |
| Yield Strength, MPa | 12.9 | 9.2 | 11.7 | 8.7 | 8.6 |
| Yield Strain, % | 21.9 | 30.1 | 16.8 | 30.0 | 30.7 |
| CO₂ Gas Permeability, barrers @ 60° C. | 58 | 47 | 104 | 51 | 47 |
| Abrasion loss, mg/1000 cycle | 91 | 71 | 64 | 43 | 30 |
| Thermal conductivity, W/m · K | 0.193 | 0.289 | 0.188 | 0.275 | 0.283 |
| Creep strain (@ 23° C., 4 MPa) after 1 week, % | 8 | 27 | 8 | 21 | 40 |

Example 3 including a cyclic olefin copolymer and a siloxane-based slip agent showed higher abrasion resistance and increased CO₂ gas permeability when compared to comparative example C-4. Example 3 showed better mechanical properties of higher harness, higher stress @ 7%, higher Young's modulus, higher yield strength, higher yield strain compared to comparative example C-3 of Table 2.

Example 4 including a cyclic olefin copolymer and a siloxane-based slip agent in a HDPE matrix showed higher abrasion resistance, increased CO₂ gas permeability, and lower creep compared to comparative example C-5 including a HDPE matrix without a cyclic olefin copolymer and without a siloxane-based slip agent.

Example 5 including a siloxane-based slip agent in a HDPE host matrix showed higher abrasion resistance and increased CO₂ gas permeability compared to comparative example C-5 including a HDPE matrix without a siloxane-based slip agent.

Without being bound by theory unless specifically set forth in the claims, it is believed that the addition of a cyclic olefin copolymer to TPE significantly increases CO₂ gas permeability. It is believed that the addition of a high-molecular-weight siloxane-based slip agent to TPE compositions increases abrasion resistance.

The compositions shown in Example 3, 4, and 5 have a high CO₂ gas permeability, good abrasion resistant layer, and good tensile properties suitable for use as one or more layers in flexible pipes for fluid transportation in petroleum production. More specifically, the compositions of Examples 3, 4, and 5 may be suited for use in a reinforcing layer, as an abrasion-resistant low-cost outer layer, and/or as an extrudable insulating layer (either as a single layer or tape).

### Thermal Conductivity of TPV Versus TPO TPE Compositions

Table 4 shows example thermoplastic olefinic (TPO) compositions made according to the present disclosure versus a comparative TPV composition (C-6). The TPO compositions (Examples 6 and 7) include an uncured rubber phase. PP1 is a polypropylene homopolymer having high melt strength and rigidity. Typical properties of PP1 include a nominal melt flow index of about 0.8 g/10 minutes, a tensile strength of about 36 MPa (50 mm/min, ASTM D638), an elongation at yield of about 10% (50 mm/min, ASTM D638), and a flexural modulus of about 1310 MPa. EXP-PP is a high melt strength (HMS) polypropylene described in US20180016414 and US20180051160 having a weight average molecular weight (M_{w}) of 540,000 g/mol, a polydispersity index of 16, and a LCB-g′ᵥᵢₛ of 0.857. The properties of the reactive polysiloxane (XIAMETER™ OFX-5084) include a SiH concentration of 0.8%, a flash point of >100° C., and a viscosity (glass capillary, 25° C.) of about 9-30 cSt.

TABLE 4

| | | |
|---|---|---|
| C-6 | Ex 6 | Ex 7 |

Formulations of the Compositions (phr)

| | | | |
|---|---|---|---|
| EPDM(E)-1 | — | — | 175 |
| EPDM(V)-1 | 200 | 200 | — |
| Polypropylene (PP1) | 515.4 | 490.4 | 451 |
| EXP-PP | — | — | — |
| Slip Agent (PDMS in hPP - Dow | — | 25 | — |
| Corning HMB-0221) | | | |
| Filler (Burgess ICECAP K ™ Clay) | 12 | 12 | 42 |
| Reactive Polysiloxane | 2.5 | — | — |
| (XIAMETER ™ OFX-5084 Si—H) | | | |
| Platinum catalyst | 0.007123 | — | — |
| Antioxidant (Calcium Stearate/ | 1.59 | 1.59 | — |
| IRGANOX ™ B4329) | | | |
| ZnO (KADOX ™ 911) | 2 | 2 | 2 |
| Process Oil (PARAMOUNT ™ | 61 | 61 | 49.32 |
| 6001R) | | | |

Properties of the Compositions (phr)

| | | | |
|---|---|---|---|
| Hardness, Shore D | 46 | 45 | 47 |
| Stress @ 7%, MPa | 11.4 | 9.4 | 11.6 |
| Young's Modulus, MPa | 384 | 347 | 488 |
| Yield Strength, MPa | 14.0 | 11.6 | 13.3 |
| Yield Strain, % | 29.7 | 25.2 | 20.6 |
| Abrasion loss, mg/1000 cycle | 70 | 37 | 91 |
| Thermal conductivity, W/m · K | 0.188 | 0.181 | 0.188 |

Table 5 shows example TPO compositions made according to the present disclosure that include an uncured rubber phase. The butyl rubber in Table 5 is a brominated copolymer of isobutylene and paramethyl styrene having a specific gravity of 0.93 kg/m³, a bromine (benzylic) content of about 1.1 mol % to about 1.3 mol %, and a Mooney viscosity (ML 1+8, 125° C.) of about 40 MU to about 50 MU. PP2 is a polymer primary composed of isotactic propylene repeat units with random ethylene distribution, and is produced using a metallocene catalyst. Typical properties of PP2 include a density of about 0.86 g/cm³, an MFI of about 1.4 g/10 minutes, a melt flow ratio of about 3, and an ethylene content of about 16 wt %. In some examples, two different grades of liquid polybutene polymer (e.g., INDOPOL™ H-8, available from Ineos Olefins & Polymers) were used. EXXONMOBIL™ PP5341 (available from ExxonMobil Chemical Company) is a polypropylene resin having a weight average molecular weight (M_{w}) of 562,000 g/mol, a polydispersity index of 7.5, and a LCB-g′ᵥᵢₛ of 1.000.

TABLE 5
Formulations of the Composition (phr)

| | Ex 8 | Ex 9 |
|---|---|---|
| Butyl rubber | 100 | 100 |
| Filler (Burgess ICECAP K ™ Clay) | 5 | 5 |
| Polypropylene (EXXONMOBIL ™ PP5431) | 164 | 280 |
| Polypropylene (PP2) | — | 3 |
| Antioxidant (IRGANOX ™ 3114) | 1 | 1 |
| Antioxidant (IRGAFOS ™ 168) | 2 | 2 |
| Light Stabilizer (TINUVIN ™ 622F) | 2 | 2 |
| PARALUX ™ Process oil | — | 12 |
| Plasticizer (INDOPOL ™ H-8) | 42.3 | — |
| Plasticizer (INDOPOL ™ H-8) | 22 | — |

In Examples 8 and 9, the thermal conductivity of the TPO compositions, having no cure was measured to be about 0.135 W/m·K. In contrast, the conventional material (a syntactic foam) is much higher at about 0.16 W/m·K. Examples 8 and 9, when compared to syntactic foam, suggest that TPO compositions can allow a reduction in the insulating layer thickness, potentially reducing material cost and pipe light weight. The exemplary compositions may also exhibit superior extruder processability over syntactic foam and crush-resistance. For example, the TPO compositions may exhibit low initial thermal conductivity, high tensile modulus (Young's modulus), high compressive strength, high specific heat capacity, and the ability to withstand temperatures greater than 100° C.) for a longer period.

Table 6 shows example butyl rubber-based TPV compositions made according to the present disclosure. Example 10 includes a Group II paraffinic oil plasticizer. The butyl rubber in Table 6 is the same as in Table 5. OPPANOL™ N50, used here as a plasticizer, is a high-molecular-weight polyisobutylene (PIB) with a weight average molecular weight (M_{w}) of 565,000 g/mol and is available from BASF Corporation. INDOPOL™ H-100, used here as a plasticizer, is a low-molecular-weight polyisobutylene available from Ineos Olefins & Polymers. Phenolic resin SP-1045 is a heat reactive, phenolic resin, available from Akrochem Corporation (Akron, Ohio, USA). Table 6 illustrates that, for butyl rubber-based TPV compositions, the addition of INDOPOL™ plasticizer to the compositions resulted in a marked improvement in thermal conductivity.

TABLE 6

| | | | | |
|---|---|---|---|---|
| Ex 10 | Ex 11 | Ex 12 | Ex 13 | Ex 14 |

Formulations of the Compositions (phr)

| | | | | | |
|---|---|---|---|---|---|
| Butyl rubber | 100 | 100 | 100 | 100 | 100 |
| Filler (Burgess ICECAP K ™ Clay) | 10 | 10 | 10 | 10 | 5 |
| Plasticizer (OPPANOL ™ N50) | — | — | — | 30 | — |
| 45% SnCl₂ in polypropylene | 1.3 | 1.3 | 1.3 | 2 | — |
| Magnesium oxide | 2 | 2 | 2 | 0.3 | — |
| ZnO (KADOX ™ 911) | 2 | 2 | 2 | 2 | 5 |
| Stearic acid | 1 | 1 | 1 | 2 | — |
| Polypropylene (EXXONMOBIL ™ | 164 | 164 | 164 | 280 | 164 |
| PP5431) | | | | | |
| Polypropylene (PP2) | — | — | — | 3 | — |
| PARAMOUNT ™ 6001 Process Oil | — | — | — | — | 54.5 |
| Phenolic resin (SP-1045) | 3.5 | 3.5 | 3.5 | 2 | — |
| Antioxidant (IRGANOX ™ 3114) | — | — | 1 | 1 | — |
| Antioxidant (IRGAFOS ™ 168) | — | — | 2 | 2 | — |
| Light Stabilizer (TINUVIN ™ 622F) | — | — | 2 | 2 | — |
| PARALUX ™ Process oil | — | — | — | 12 | — |
| Plasticizer (INDOPOL ™ H-8) | 41.1 | 64.3 | 64.3 | — | — |
| Plasticizer (INDOPOL ™ H-100) | 23.2 | — | — | — | — |

Properties of the Compositions

| | | | | | |
|---|---|---|---|---|---|
| Thermal conductivity (at 23° C.), W/m · K | 0.14 | 0.14 | 0.14 | 0.16 | 0.16 |
| Specific gravity | 0.937 | 0.931 | 0.933 | 0.931 | 0.93 |
| Hardness, Shore D | 32 D | 38 D | 39 D | 48 D | 38D |
| Tensile Strength at break (MPa) | 16.9 | 16.4 | 16.2 | 18.9 | 14 |
| Elongation at break (%) | 524 | 528 | 544 | 675 | 400 |
| Creep time to reach 10⁻⁸ compliance by | 1500 | 1500 | 1500 | 1500 | 2000 |
| DMTA (seconds) at 20° C. | | | | | |
| Young's Modulus (MPa) @ 23° C. | 218 | — | — | 599 | 151 |
| Young's Modulus (MPa) @ 90° C. | 134 | — | — | 294 | — |
| Compressive strength @ 23° C. | — | — | — | — | 126 |
| Coefficient of linear thermal expansion | — | — | — | — | 129 |
| (μm/m · ° C.) | | | | | |

Table 7 shows example EPDM rubber-based TPV compositions with Group II paraffinic oil plasticizers made according to the present disclosure. The curative system includes a reactive siloxane (XIAMETER™ OFX-5084 described above), a platinum catalyst, stannous chloride, and zinc oxide. Comparison of properties of each composition listed in Table 7 suggests that the use of a Group II oil can influence the thermal conductivity and other properties of the compositions.

TABLE 7

| | | |
|---|---|---|
| Ex 15 | Ex 16 | Ex 17 |

Formulations of the Compositions (phr)

| | | | |
|---|---|---|---|
| EPDM(E)-1 | 175 | — | — |
| EPDM (V)-1 | — | 200 | 200 |
| Filler (Burgess ICECAP K ™ | 42 | 42 | 42 |
| Clay) | | | |
| 45% SnCl₂ in polypropylene | 1.67 | — | — |
| ZnO (KADOX ™ 911) | 2 | 2 | 2 |
| Polypropylene (PP1) | 451 | 200 | 515.4 |
| PARAMOUNT ™ 6001 Process | 49.32 | 65 | 61 |
| Oil | | | |
| Phenolic resin in oil (HRJ-16261) | 12.82 | — | — |
| Reactive Polysiloxane | — | 2.5 | 2.5 |
| (XIAMETER ™ OFX-5084 | | | |
| Si—H) | | | |
| Antioxidant (Calcium Stearate/ | — | 1.59 | 1.59 |
| IRGANOX ™ B4329) | | | |
| Platinum catalyst | — | 0.007123 | 0.007123 |

Properties of the Compositions

| | | | |
|---|---|---|---|
| Thermal conductivity (at 23° C.), | 0.185 | 0.184 | 0.185 |
| W/m · K | | | |
| Specific gravity | 0.931 | 0.933 | 0.921 |
| Hardness, Shore D | 48D | 30D | 46D |
| Tensile strength at yield (MPa) | 12.9 | — | 14.0 |
| Young's Modulus (MPa) @ 23° C. | 434 | 76 | 384 |

Table 8 shows example EPDM rubber and butyl-based TPO compositions according to the present disclosure. The data presented in Table 8 suggests that the thermal conductivity may be lowered by the use of non-cross-linked rubber.

TABLE 8

| | | |
|---|---|---|
| Ex 18 | Ex 19 | Ex 20 |

Formulations of the Compositions (phr)

| | | | |
|---|---|---|---|
| EPDM(E)-1 | 175 | — | — |
| Butyl rubber | — | 100 | 100 |
| Filler (Burgess ICECAP K ™ Clay) | 42 | 5 | 5 |
| ZnO (KADOX ™ 911) | 2.00 | — | — |
| Polypropylene (EXXONMOBIL ™ PP5431) | 451 | 164 | 280 |
| PARAMOUNT ™ 6001 Process Oil | 49.32 | — | 12 |
| Antioxidant (IRGANOX ™ 3114) | — | 1 | 1 |
| Antioxidant (IRGAFOS ™ 168) | — | 2 | 2 |
| Light Stabilizer (TINUVIN ™ 622F) | — | 2 | 2 |
| Plasticizer (INDOPOL ™ H-8) | — | 64.3 | 1.59 |
| Polypropylene (PP2) | — | — | 3 |

Properties of the Compositions

| | | | |
|---|---|---|---|
| Thermal conductivity (at 23° C.), W/m · K | 0.188 | 0.142 | 0.155 |
| Specific Gravity | 0.931 | 0.912 | 0.917 |
| Hardness, Shore D | 47D | 31D | 48D |
| Young's Modulus (MPa) @ 23° C. | 488 | 215 | 562 |

Table 9 shows example EPDM rubber and butyl based-TPO compositions prepared according to the present disclosure.

TABLE 9

Ex 21

Formulations of the Composition (phr)

| | |
|---|---|
| Butyl rubber | 100 |
| Polypropylene (EXXONMOBIL ™ PP5431) | 164 |
| Filler (Burgess ICECAP K ™ Clay) | 5 |
| ZnO (KADOX ™ 911) | 5 |
| Phenolic resin in oil (HRJ-16261) | 14 |
| PARAMOUNT ™ 6001 Process Oil | 54.5 |

Properties of the Compositions

| | |
|---|---|
| Thermal conductivity (at 23° C.), W/m · K | 0.155 |
| Specific heat capacity, J/kg · K at 110° C. | 3283 |
| Water absorption, at room temp for 28 days | 1% |
| Density (g/cm³) | 0.93 |
| Homogenous tensile (MPa, room temperature) | 16.6 |
| Jointed tensile (MPa, room temperature) | 7.6 |
| Hardness (Shore D) | 38 |
| Glass Transition Temperate (° C.) | −59.9 |
| Compressive strength (MPa at 23° C.) | 126 |
| Coefficient of linear thermal expansion (μm/m · ° C.) | 129 |

The data presented in Table 9 suggests that the TPO compositions made according to the present disclosure may display properties, such as thermal conductivity of about 0.20 W/(m·K) or less, beneficial in manufacturing material to insulate oil and gas pipelines. Such beneficial properties may also include a small change of thermal conductivity under heat and seawater exposure, high tensile modulus (greater than about 300 MPa), a high compressive strength (greater than about 10 MPa), high specific heat capacity (greater than about 1300 J/kg·K), and the ability to withstand temperatures greater than about 100° C.

Table 9 also presents data suggesting that the TPE compositions may be suitable for use in an external coating positioned as thermal insulation material around non-flexible pipes conveying oil and/or gas production in submerged water service for flow assurance purposes. The TPE compositions may display better thermal insulation properties than glass-syntactic polypropylene or pure polypropylene, thereby allowing thinner insulating layers and consequently, reduction of pipe outer diameter and pipe laying cost. Notably, the thermal properties of the TPE compositions of the present disclosure may be achieved without the addition of glass microspheres. Multi-layer, glass-syntactic (GS), polypropylene thermal insulation systems, applied as an outer layer around non-flexible (currently metallic or in future fully-bonded, multi-layer, thermoplastic composite) pipes conveying oil and/or gas production in subsea service for flow assurance purposes, have multiple limitations: (1) A reduced application process rate of the GS layer because of the glass microsphere additive, resulting in higher viscosity and glass microsphere breakage at high shear conditions; (2) an increased extrusion tooling wear rate with the GS layer because of the abrasive nature of glass microsphere additive; (3) an increased process complexity, longer setup and changeover times due to the glass microsphere additive; (4) a reduced thermal resistance at the insulation applied over welded pipe joints in the field due to the removal of glass microsphere additive to enable application by injection molding; (5) an increased susceptibility to cracking during reel-lay installation at or near the interface between the factory-applied material on the pipe body and the field-applied material over welded joints because of the mechanical property differences and the low tensile elongation limit of the material in the GS layer; (6) the rate of cracking in (5) increases with reel-lay installation in colder weather; (7) an increased process cost & complexity due to the application of an outermost protective layer without a glass microsphere additive; (8) an increased misapplication risk due to the water depth dependency of the grade of glass microsphere selected; and (9) a reduced maximum application temperature capability due to hot water hydrolysis of the glass-syntactic polyurethane.

These limitations are largely avoided using the TPE compositions of the present disclosure. Further, the TPE compositions of the present disclosure may exhibit excellent tensile elongation and a lower low-temperature flexibility limit, both properties of which may be useful in manufacturing non-flexible pipes to be used in subsea oil field applications as thermal insulation material.

Table 10 shows example butyl based TPV compositions made from an isobutylene-paramethylstyrene rubber with a paramethylstyrene derived content in the range of 7 wt % to 12 wt % based on the total weight of the rubber. Talc is SG-2000 talc powder from Nippon Talc. Maglite D is magnesium oxide from HallStar. ESCOREZ 5320 is a commercially available hydrocarbon resin (ExxonMobil Chemical Company). SP1045 is a commercially available phenolic resin available from SI Group. Diak 4 is 4,4′-methylenebis(cyclohexylamine)carbamate available from Vanderbilt Chemicals. MF650Y is Metocene MF650Y polypropylene available from LyondellBassell. Oil added before curing is indicated in Table 7 as “(pre)” and oil added after 5 minutes of curing is indicated as “(post)”.

TABLE 10
Example of TPV Compositions

| Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|
| 22 | 23 | 24 | 25 | 26 | 27 | 28 | 29 | 30 | 31 | 32 | 33 | 34 |

Formulations of the Compositions (phr)

| | | | | | | | | | | | | | |
|---|---|---|---|---|---|---|---|---|---|---|---|---|---|
| Butyl Rubber (Exxpro | 100 | 100 | 100 | 100 | 100 | 100 | 100 | 100 | 100 | 100 | 100 | 100 | 100 |
| 3563) | | | | | | | | | | | | | |
| MF650Y | — | — | — | — | — | — | — | — | — | — | 34 | — | — |
| Braskem F180A | — | — | — | — | — | — | 168 | — | — | 68 | 34 | — | — |
| PP5341 | 25 | 168 | 168 | 168 | 168 | 168 | — | 168 | 68 | — | — | 68 | 168 |
| Icecap clay | 4.8 | 10 | — | 10 | 40 | 10 | 10 | 10 | — | — | — | — | 10 |
| Talc | — | — | 10 | — | — | — | — | — | — | — | — | — | — |
| Paramount 6001 (pre) | — | — | — | 31.2 | — | 32.3 | — | — | — | — | — | — | — |
| Paramount 6001 (post) | — | — | — | 22.6 | — | 32 | — | — | — | — | — | — | — |
| Indopol H100 (pre) | 30 | 32.3 | 32.3 | — | 32.3 | — | 32.3 | 32.3 | 32.3 | 32.3 | 32.3 | 32.3 | 32.3 |
| Indopol H100 (post) | 34.3 | 32 | 32 | — | 32 | — | 32 | 32 | 32 | 32 | 32 | 32 | 32 |
| Stearic acid | 1 | 1 | 1 | 1 | 1 | 1 | 1 | — | 1 | 1 | 1 | 1 | — |
| SnCl2 | 1.3 | 1.3 | 1.3 | 1.3 | 1.3 | 1.3 | 1.3 | — | 1.3 | 1.3 | 1.3 | 1.3 | — |
| ZnO | 2 | 2 | 2 | 2 | 2 | 2 | 2 | 2 | 2 | 2 | 2 | 2 | — |
| Maglite D | 2 | 2 | 2 | 2 | 2 | 2 | 2 | — | 2 | 2 | 2 | 2 | — |
| Escorez 5320 | 16.5 | 16.5 | 16.5 | 16.5 | 16.5 | 16.5 | 16.5 | 16.5 | 16.5 | 16.5 | 16.5 | — | 16.5 |
| HRJ 16261 | — | — | — | 14 | — | — | — | — | — | — | — | — | — |
| SP1045 | 3.5 | 3.5 | 3.5 | — | 3.5 | 3.5 | 3.5 | 3.5 | 3.5 | 3.5 | 3.5 | 3.5 | — |
| Diak 4 | | | | | | | | | | | | | 1.75 |
| Total Amount | 220.4 | 368.6 | 368.6 | 368.6 | 398.6 | 368.6 | 368.6 | 364.3 | 258.6 | 258.6 | 258.6 | 242.1 | 360.55 |

Properties of the Compositions

| | | | | | | | | | | | | | |
|---|---|---|---|---|---|---|---|---|---|---|---|---|---|
| Specific gravity (ISO | 0.96 | 0.95 | 0.95 | 0.94 | 0.99 | 0.94 | 0.95 | 0.94 | 0.94 | 0.94 | 0.94 | 0.93 | 0.94 |
| 1183) | | | | | | | | | | | | | |
| Hardness (ISO 868) | 39 A | 37 D | 37 D | 35 D | 38 D | 37 D | 37 D | 37 D | 75 A | 77 A | 77 A | 78 A | 39 D |
| Tensile strength at | 4.5 | 13.5 | 13.3 | 15 | 14 | 14.6 | 14.2 | 14.1 | 9.3 | 8.6 | 7 | 8.8 | 10.7 |
| break (MPa, ASTM | | | | | | | | | | | | | |
| D412) | | | | | | | | | | | | | |
| Elongation at break | 362 | 428 | 407 | 441 | 479 | 387 | 457 | 457 | 438 | 395 | 422 | 379 | 363 |
| (%, ASTM D412) | | | | | | | | | | | | | |
| Strength at 100% | 1.2 | 9.3 | 9.4 | 8.9 | 9.3 | 9.3 | 9.5 | 9.4 | 4.1 | 4.2 | 3.8 | 4.4 | 9 |
| elongation (MPa, ASTM | | | | | | | | | | | | | |
| D412) | | | | | | | | | | | | | |
| Weight gain in IRM903 | 88.5 | 20.8 | 22.6 | 21.7 | 20.9 | 21.6 | 22.3 | 19.7 | 52.9 | 49.8 | 54.5 | 46.3 | 25.3 |
| (%, 24 hr @ 121° C., | | | | | | | | | | | | | |
| TPE 0145/1) | | | | | | | | | | | | | |
| Tension set (%, 100% | 4 | 43.5 | 44.3 | 36 | 43.8 | 36.8 | 43 | 45.2 | 20.2 | 19 | 22.8 | 20.8 | 46.8 |
| elongation, 10 min at | | | | | | | | | | | | | |
| RT, release 10 min, | | | | | | | | | | | | | |
| TPE 0053) | | | | | | | | | | | | | |

The results show that the TPV and TPO compositions made according to the present disclosure can have excellent properties to insulate oil and gas pipelines such as excellent thermal conductivity of <0.2 W/(m·K), a small change of thermal conductivity under heat and seawater exposure, high tensile modulus (>300 MPa), high compressive strength (>10 MPa), high specific heat capacity (>1300 J/kg·K), and have the ability to withstand temperature >100° C.

The results also show that the TPV and TPO compositions can be used in an external coating positioned as thermal insulation material around non-flexible pipes conveying oil and/or gas production in submerged water service for flow assurance purposes. The TPV and TPO compositions can have better thermal insulation properties than glass-syntactic polypropylene or pure polypropylene, which translates to thinner insulation layers and consequent reduction of pipe outer diameter and pipe laying cost. The thermal properties of the TPV and TPO compositions of the present disclosure can be achieved without the addition of glass microspheres thus addressing the aforementioned related limitations of glass-syntactic polypropylene and polyurethane systems. The TPV and TPO compositions of the present disclosure can have lower thermal conductivity without utilizing glass microspheres, a higher tensile elongation property, and a lower, low-temperature flexibility limit, which can be a benefit to non-flexible pipes in subsea oil field applications as thermal insulation material.

The TPE compositions prepared according to the methods disclosed herein may display a substantially higher tensile elongation property when compared to glass-syntactic polypropylene and polyurethane systems, which may be retained during reel-lay, even at low temperatures. Thus, pipes prepared using the TPE compositions disclosed herein may be less susceptible to cracking at or near the interface between the factory-applied material on the pipe body and the field-applied material over welded joints. The data shown in Table 9 also suggests that the TPE compositions may resist degradation in hot water, such as water at temperatures of about 140° C. to about 150° C. In contrast, conventional glass-syntactic polyurethane is only resistant to degradation temperatures up to about 100° C. Although conventional glass-syntactic polypropylene may exhibit degradation resistance at temperatures approaching 140° C. to 150° C., the TPE compositions of the present disclosure exhibit a multitude of other advantageous qualities when compared to glass-syntactic polypropylene and therefore still promises to have a longer lifetime than conventional glass-syntactic polypropylene.

Any composition described herein may include a high temperature resistant thermoplastic olefin that provides good thermal conductivity properties. Any composition described herein may exhibit very low thermal conductivity, for example, by selection of the rubber phase. For example, a very low thermal conductivity may be obtained when using butyl rubber as the rubber phase. In addition, any composition described herein may exhibit substantial low-temperature crack resistance when compared to the low-temperature crack resistance of conventional thermoplastics.

### Test Methods

The properties of the TPE compositions were determined by the following physical testing procedures.

Abrasion loss was measured according to ASTM D4060-14 in which the method was performed on both sides of a 4 inch circular specimen cut from the plaques provided. Wheel H-22 was used with 1 kg weight and 1000 revolutions. The wheel was resurfaced before testing each specimen (or after every 1000 cycles).

Carbon dioxide gas permeability was measured according to ISO 2782-1: 2012 (E) in which the thickness of each sample was measured at 5 points homogeneously distributed over the sample permeation area. The test specimen was bonded onto the holders with suitable adhesive cured at the test temperature. The chamber was evacuated by pulling vacuum on both sides of the film. The high pressure side of the film was exposed to the test pressure with CO₂ gas at 60° C. The test pressure and temperature was maintained for the length of the test, recording temperature and pressure at regular intervals. The sample was left under pressure until steady state permeation has been achieved (3-5 times the time lag (τ)).

Coefficient of linear thermal expansion was measured according to ASTM E831-19.

Compressive strength was measured according to ASTM D575-91(2018).

Creep strain was measured by conditioning the test samples according to ASTM Lab conditions at 23±2° C. and 50±10% relative humidity. Conditioning time was not less than 40 hours under lab conditions and was not less than 48 hours after fabrication. Strips with dimensions of 15 mm width×250 mm length (0.591 inches wide by 9.85 inches long) were cut from compression molded sheet samples. The test area 100 mm was clamped and loaded with weights to achieve a total stress of 4 MPa. The creep strain was measured as a function of time for a week at 23° C.

Creep time was tested by applying a stress of 0.100 MPa was applied to the rectangular specimens with a dual cantilever fixture for twenty minutes at 20° C. and is reported in seconds(s) to achieve 10⁻⁸/Pa compliance by the DMA.

Crystallinity was determined by dividing the heat of fusion (H_{f}) of a sample by the heat of fusion of a 100% crystalline polymer, which is assumed to be 209 joules/gram for polypropylene.

Elongation at break and elongation at yield, unless otherwise indicated, was measured according to ISO37.

Flexural modulus was measured according to ASTM D790A (1.3 mm/min).

Glass transition temperature (T_{g}), crystallization temperature (T_{c}), melting temperature (Tₘ), and heat of fusion (H_{f}) were measured either mechanically by dynamic mechanical thermal analysis (DMTA) on an MCR 301 or thermally by DSC. For DMTA analysis, the frequency of temperature sweep was 0.1 Hz, and deformation was set at 2%, temperature range was −80° C. to 140° C., ramp increased at a speed of 2° C./min. The test sample was cut from 4 mm thick tape. For DSC analysis, ASTM standard E1356-08(2014) was used.

Melt flow index (MFI) and melt flow ratio were measured at 230° C., 2.16 kg weight according to ASTM D1238-13.

Unless otherwise indicated, the distribution and the moments of molecular weight (M_{w}, Mₙ, M_{z}, M_{w}/Mₙ, etc.) and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon™ filter and degassed with an online degasser before entering the GPC instrument. The nominal flow rate is 1.0 mL/min, and the nominal injection volume is 200 μL. The whole system including transfer lines, columns, and detectors is contained in an oven maintained at 145° C. The polymer sample is weighed and sealed in a standard vial with 80-μL flow marker (heptane) added to it. After loading the vial in the autosampler, polymer is dissolved in the instrument with 8 mL added TCB solvent. The polymer is dissolved at 160° C. with continuous shaking for about 1 hour for polyethylene samples or about 2 hours for polypropylene samples. The TCB densities used in concentration calculation is 1.463 g/ml at room temperature and 1.284 g/mL at 145° C. The sample solution concentration is from 0.2 to 2.0 mg/mL, with lower concentrations being used for higher molecular weight samples. The concentration (c), at each point in the chromatogram is calculated from the baseline-subtracted IR5 broadband signal intensity (I), using the following equation: c=βI, where β is the mass constant. The mass recovery can be calculated from the ratio of the integrated area of the concentration chromatography over elution volume and the injection mass, which is equal to the pre-determined concentration multiplied by injection loop volume. The conventional molecular weight (IR molecular weight) is determined by combining universal calibration relationship with the column calibration, which is performed with a series of monodispersed polystyrene (PS) standards ranging from 700 to 10,000,000 gm/mole. The molecular weight at each elution volume is calculated according to:

$$log M = \frac{log ( {K}_{PS} / K )}{a + 1} + \frac{{a}_{PS} + 1}{a + 1} log {M}_{PS}$$

where the variables with subscript “PS” stand for polystyrene while those without a subscript are for the test samples. In this method, α_{PS}=0.67 and K_{PS}=0.000175 while a and K for other materials are as calculated and published in literature (Sun, T. et al. Macromolecules 2001, 34, 6812), except that for purposes of this disclosure and claims thereto, α=0.705 and K=0.0002288 for linear propylene polymers, α=0.695 and K=0.000181 for linear butene polymers, α is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, and a is 0.695 and K is 0.000579*(1-0.0077*w2b) for ethylene-octene copolymer where w2b is a bulk weight percent of octene comonomer, and α=0.695 and K=0.000579 for all other linear ethylene polymers. Concentrations are expressed in g/cm³, molecular weight is expressed in g/mole, and intrinsic viscosity (hence K in the Mark-Houwink equation) is expressed in dL/g, unless otherwise noted.

The LS detector is the 18-angle Wyatt Technology High Temperature DAWN™ HELEOS II. The LS molecular weight (M) at each point in the chromatogram is determined by analyzing the LS output using the Zimm model for static light scattering (Light Scattering from Polymer Solutions; Huglin, M. B., Ed.; Academic Press, 1972) according to:

$$\frac{{K}_{o} c}{Δ R ( θ )} = \frac{1}{MP ( θ )} + 2 {A}_{2} c$$

In Eq. 6, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system from:

$${K}_{o} = \frac{4 {π}^{2} {{n}^{2} ( dn / dc )}^{2}}{{λ}^{4} {N}_{A}}$$

where N_{A} is Avogadro's number, and (dn/dc) is the refractive index increment for the system. The refractive index, n=1.500 for TCB at 145C and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1-0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηᵢₛ, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated according to:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined according to:

$${g}_{vis}^{′} = \frac{{[ η ]}_{avg}}{{KM}_{v}^{α}}$$

where M_{V} is the viscosity-average molecular weight based on molecular weights determined by LS analysis and the K and α are for the reference linear polymer, which are, for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

Mooney Viscosity (ML (1+4) at 125° C.) was measured according to ASTM-1646-19a. Mooney Viscosity (ML (1+8) at 125° C.) was also measured according to ASTM-1646-19a. Non-Mooney Viscosity (“simply referred to as “viscosity” in this disclosure) was measured by a Brookfield viscometer according to ASTM D-4402-15 at 38° C.

Ring and Ball (R&B) softening point can be measured by the method described in ASTM E28-18, which is incorporated herein by reference.

Shore Hardness was measured according to ASTM D2240-15e1, with a 15-second delay using a Shore D scale or a Shore A scale.

Specific heat capacity was measured according to ASTM E1269-11(2018).

Tensile strength at yield was measured according to ISO 37 unless otherwise indicated.

Thermal conductivity was measured according to ASTM C518-17 in which the method was performed on TA FOX50-190 instrument. Plastics plaques were die cut into disc specimens of two-inch diameter. The specimens were measured at 25° C. and 90° C. Each material was measured in duplicate.

Vicat softening point was measured according to ASTM D1525-17.

Water absorption was measured according to ASTM D570-98(2018).

Young's Modulus, Stress @ 7%, yield strength, and yield strain were measured according to ISO 37:2017. The samples were tested using a crosshead speed of 2 inches/minute at 23° C.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the embodiments disclosed herein are presented herein. Not all features of a physical implementation are described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related and other constraints, which vary by implementation and from time to time. While a developer's efforts might be time consuming, such efforts would be, nevertheless, a routine undertaking for those of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure and embodiments described therein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The various embodiments disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

1-57. (canceled)

58. A spoolable pipe comprising:
a barrier layer formed around a longitudinal axis of the pipe;
a reinforcing layer disposed around the barrier layer comprising a fiber material; and
an outer layer, wherein at least one of the reinforcing layer and the outer layer comprises a thermoplastic elastomer (TPE) composition comprising a thermoplastic matrix and a rubber phase dispersed in the thermoplastic matrix and having a thermal conductivity of about 0.2 W/m·K or less.

59. The spoolable pipe of claim 58, wherein the reinforcing layer comprises a first ply of reinforcing tape helically wrapped in a first helical direction about the barrier layer and a second ply of reinforcing tape helically wrapped about the first ply of reinforcing tape in a second helical direction counter to the first helical direction, and wherein the reinforcing layer is at least partially bonded to an outer surface of the barrier layer.

60. The spoolable pipe of claim 58, wherein the TPE composition further exhibits at least one of the following properties at 23° C.: (b) a tensile modulus of at least about 50 MPa; (c) a compressive strength of at least about 10 MPa; and (d) a specific heat capacity of 1300 J/kg·K or more.

61. The spoolable pipe of claim 58, wherein the TPE composition comprises a rubber that is at least partially cross-linked.

62. The spoolable pipe of claim 58, wherein the TPE composition comprises a rubber that is not cross-linked.

63. The spoolable pipe of claim 58, wherein the outer layer is disposed around the reinforcing layer in one or more of the following manners: extruded onto the reinforcing layer, sprayed onto the reinforcing layer, applied as a dipped coating around the reinforcing layer, wound as a tape around the reinforcing layer, shrink-wrapped around the reinforcing layer, and braided around the reinforcing layer.

64. The spoolable pipe of claim 58, wherein the outer layer is extruded onto the reinforcing layer.

65. The spoolable pipe of claim 58, wherein the outer layer is wound around the reinforcing layer using a tape placement method.

66. The spoolable pipe of claim 58, wherein the thermoplastic matrix comprises a thermoplastic polyolefin.

67. The spoolable pipe of claim 58, wherein the TPE composition further comprises about 0.1 wt % to about 30 wt % of a cyclic olefin copolymer.

68. The spoolable pipe of claim 58, wherein the TPE compositions further comprises about 1 wt % to about 10 wt % of a siloxane-based slip agent.

69. The spoolable pipe of claim 58, wherein the TPE composition further comprises a cure system selected from the group consisting of: a phenolic resin, a peroxide, a maleimide, a hexamethylene diamine carbamate, a silicon-based curative, a metal oxide, a silane-based curative, and a sulfur-based curative.

70. The spoolable pipe of claim 58, wherein the TPE composition comprises about 5 wt % to about 50 wt % of the rubber phase and about 50 wt % to about 95 wt % of the thermoplastic phase.

71. The spoolable pipe of claim 66, wherein the thermoplastic polyolefin comprises one or more of polypropylene, polyethylene, and butene.

72. The spoolable pipe of claim 66, wherein the thermoplastic polyolefin comprises high-density polyethylene.

73. The spoolable pipe of claim 71, wherein the polypropylene is a homopolymer, a random copolymer, or an impact copolymer.

74. The spoolable pipe of claim 71, wherein the polypropylene is a high melt strength (HMS) long-chain branched (LCB) polypropylene homopolymer.

75. The spoolable pipe of claim 71, wherein the polypropylene has one or both of an MFI of about 0.1 g/10 minutes to about 10 g/10 minutes and a molecular weight (Mw) of about 100,000 g/mol to about 1,000,000 g/mol.

76. The spoolable pipe of claim 58, wherein the rubber phase comprises one or more of an ethylene-propylene rubber, a poly-α-olefin elastomer, a nitrile rubber, and a butyl rubber.

77. The spoolable pipe of claim 76, wherein the ethylene-propylene rubber comprises one or both of ethylidene norbornene and vinyl norbornene.

78. The spoolable pipe of claim 76, wherein the poly-α-olefin elastomer comprises one or more of an ethylene-octene copolymer and an ethylene-butene copolymer.

79. The spoolable pipe of claim 76, wherein the butyl rubber comprises one or more of isobutylene-isoprene rubber, brominated isobutylene-isoprene rubber, and isobutylene paramethylstyrene rubber.

80. The spoolable pipe of claim 58, wherein the TPE composition has a Vicat softening point of about 100° C. to about 200° C.

81. The spoolable pipe of claim 58, wherein the TPE composition has an abrasion loss of not more than about 60 mg/1000 cycle-ranges.

82. The spoolable pipe of claim 58, wherein the TPE composition has a Young's Modulus of about 100 MPa and a carbon dioxide permeability of at least about 25 barrers
$$( 2.5 \frac{{cm}_{STP}^{3} \cdot cm}{{cm}^{2} \cdot s \cdot cm Hg} ) .$$

83. The spoolable pipe of claim 58, wherein the TPE composition further comprises a mineral oil wherein the mineral oil comprises one or more of an aromatic oil, a naphthenic oil, a paraffinic oil, and an isoparaffinic oil; the paraffinic oil comprises one or more of a Group I oil, a Group II oil, and a Group III oil; and the synthetic oil comprises one or more of a polyalphaolefin, polyisobutylene, a polybutenes, and an alkylyl ester.

84. The spoolable pipe of claim 58, wherein the TPE composition further comprises about 20 phr to about 100 phr of a polyolefin hardener, and wherein the polyolefin hardener is a light polyisobutene oil having a Mₙ from about 200 g/mol to about 6000 g/mol.

85. The spoolable pipe of claim 58, wherein the TPE composition further comprises a plasticizer and wherein the plasticizer comprises one or more of a low-molecular-weight ester plasticizer and triisononyl trimellitate.

86. The spoolable pipe of claim 58, wherein the TPE composition further comprises a filler and wherein the filler comprises one or more of calcium carbonate, clay, silica, talc, a metal oxide, carbon black, mica, and wood flour.

87. The spoolable pipe of claim 58, wherein the TPE composition exhibits a long-term temperature withstand capability of at least about 130° C.
